(19) United States
(12) Patent Application Publication
(10) Pub. No.: US 2025/0229263 A1
(43) Pub. Date: Jul. 17, 2025

(54) CATALYST AND METHOD FOR PRODUCING CATALYST

(71) Applicant: ASAHI KASEI KABUSHIKI KAISHA, Tokyo (JP)

(72) Inventors: Yuya OKA, Tokyo (JP); Kohei MORIYA, Tokyo (JP)

(73) Assignee: ASAHI KASEI KABUSHIKI KAISHA, Tokyo (JP)

(21) Appl. No.: 18/845,281

(22) PCT Filed: Mar. 10, 2023
(86) PCT No.: PCT/JP2023/009277

§ 371 Date: Sep. 9, 2024

(30) Foreign Application Priority Data
Mar. 10, 2022 (JP) 2022-036981

(51) Int. Cl. B01J 37/00; B01J 23/28; B01J 35/40; B01J 35/51

(52) U.S. Cl. CPC B01J 37/0009; B01J 23/28; B01J 35/40; B01J 35/51; B01J 2235/00

(57) ABSTRACT

A catalyst that is used in a gas phase catalytic oxidation reaction or gas phase catalytic ammoxidation reaction of propane or isobutane, in which
the catalyst contains catalyst particles each having a composite metal oxide and a support that supports the composite metal oxide,
the catalyst particles have a median diameter of 20 μm or more and 150 μm or less,
a shape of the catalyst particle is spherical, and
in a binarization processed image BP₂ obtained by performing a binarization process for classifying regions into a predetermined white region and a predetermined black region on a cross-sectional image showing the catalyst particles and having an area of 1200 μm² or more obtained by predetermined SEM backscattered electron image observation, σ/A that is calculated by a predetermined method satisfies 0.10 or more and 0.30 or less.

### TECHNICAL FIELD

The present invention relates to a catalyst and a method for producing a catalyst.

### BACKGROUND ART

A method for producing an unsaturated nitrile by reacting an olefin, molecular oxygen, and ammonia is known as “ammoxidation reaction”, and this reaction is being used globally as an industrial method for producing an unsaturated nitrile. Incidentally, in recent years, attention has been paid to a method for producing a corresponding unsaturated nitrile by performing a gas phase catalytic ammoxidation reaction using an alkane such as propane or isobutane as a starting material instead of the olefin, and a method for producing a catalyst therefor has been also drawing attention.

In Patent Literature 1, the use of a composite oxide that is particles having a metal oxide containing molybdenum (Mo), vanadium (V), and antimony (Sb) and a silica support, in which Sb has been dispersed in the particles and the degree of dispersion of Sb is 0.80 to 1.3, as a catalyst for producing an unsaturated nitrile is proposed. In addition, as a method for producing the composite oxide, a method including a starting material compounding step of preparing a starting material-compounded solution, a drying step of drying the starting material-compounded solution to obtain a dry powder, and a calcining step of calcining the dry powder to obtain a calcined product is proposed. More specifically, a method in which the calcining step is performed in two stages and the heating rate in the second stage of calcining is adjusted is proposed.

In Patent Literature 2, as a method for producing an oxide catalyst, the production of an oxide catalyst in which the redox potential of a predetermined starting material in a starting material compounding step is adjusted and the yield of unsaturated nitrile is high is proposed.

### CITATION LIST

### Patent Literature

Patent Literature 1: JP 6310751 B2
Patent Literature 2: WO 2018/025774 A2

### SUMMARY OF INVENTION

### Technical Problem

According to the catalysts for producing acrylonitrile described in Patent Literature 1 and 2, it is possible to improve the yield of unsaturated nitrile; however, recently, there has been a tendency that higher catalyst performance is sought, and there is thus room for additional improvement.

Particularly, in ammoxidation reactions, activation of ammonia with a catalyst is essential. However, it is sometimes observed that activated ammonia merely burns and turns into nitrogen, without making any contribution to ammoxidation reaction. The use of ammonia, that is slightly excessively used for propane being a C component, in a highly efficient manner is a problem relating to the economic efficiency of the process as well, but cannot be said to be sufficiently studied in the conventional art.

The present invention has been made in consideration of the above-described problem, and an objective of the present invention is to provide a catalyst and a method for producing a catalyst that enable the highly efficient use of ammonia and the production of acrylonitrile at a high yield.

### Solution to Problem

As a result of studies for solving the above-described problem, the present inventors have found that a catalyst, in which a crystal phase has been homogeneously grown and distributed, can be designed when its parameter obtained by performing a predetermined image analysis is controlled to be within a predetermined range, and such a catalyst is capable of solving the above-described problem and completed the present invention.

That is, the present invention is as described below.

[1]

A method for producing a catalyst that is used in a gas phase catalytic oxidation reaction or gas phase catalytic ammoxidation reaction of propane or isobutane, the method comprising:
a drying step of drying a precursor of the catalyst to obtain dry particles;
a first supplying step of supplying the dry particles to a first cylindrical body; and
a first calcining step of calcining the dry particles supplied to the first cylindrical body to obtain first calcined particles,
wherein the first cylindrical body comprises a supply port P1 that supplies the dry particles into the cylindrical body at one end T1 side, a carry-out port P2 that carries out the calcined particles to an outside of the cylindrical body at the other end T2 side, the T1 and T2 sides being arranged in a rotation axis direction of the cylindrical body, and heating means M1 that heats an inside of the cylindrical body along the rotation axis direction, and
a variation range of a temperature A of a supply port P1 side in the first cylindrical body is 10° C. or less.
   [2]

The method for producing the catalyst according to [1], wherein:
the first cylindrical body further comprises a plurality of temperature measurement means M2, that measure temperatures of substantially a central portion along the rotation axis direction, in the cylindrical body,
in the first supplying step, the dry particles are supplied to the supply port P1 by gas transportation,
the temperature A is measured by temperature measurement means M2′ out of the temperature measurement means M2, the temperature measurement means M2′ being disposed on the supply port P1 side, and
the temperature A is adjusted by controlling a temperature of a gas that is used for the gas transportation.
   [3]

The method for producing the catalyst according to [2], wherein, in the gas transportation, an inert gas is used.

[4]

The method for producing the catalyst according to [2] or [3], wherein a supply rate of the dry particles to the supply port P1 is 0.1 kg/hr or higher and 100 kg/hr or lower per cubic meter of a volume of the first cylindrical body.

[5]

The method for producing the catalyst according to any of [1] to [4], wherein:
in the drying step, spray drying of the precursor is performed,
in the first supplying step, the dry particles are continuously supplied, and
in the first calcining step, the dry particles are continuously calcined, and a maximum reached temperature is 350° C. to 500° C.
   [6]

The method for producing the catalyst according to any of [1] to [5], wherein, in the first calcining step, a temperature is controlled by the heating means M1 such that the temperature A reaches a target temperature t1 selected from 100° C. to 300° C. and/or a temperature B of a carry-out port P2 side of the first cylindrical body reaches a target temperature t2 selected from 350° C. to 500° C.

[7]

The method for producing the catalyst according to any of [1] to [6], further comprising:
a second supplying step of supplying the first calcined particles to a second cylindrical body; and
a second calcining step of calcining the first calcined particles supplied to the second cylindrical body to obtain second calcined particles.
   [8]

The method for producing the catalyst according to [7], wherein:
in the second supplying step, the first calcined particles are continuously supplied, and
in the second calcining step, the first calcined particles are continuously calcined, and a maximum reached temperature is 600° C. to 800° C.
   [9]

The method for producing the catalyst according to [7] or [8], wherein:
the second cylindrical body comprises a supply port P3 that guides the first calcined particles into a cylindrical body at one end T3 side, a carry-out port P4 that carries out the first calcined particles at the other end T4, the T3 and T4 sides being arranged in a rotation axis direction of the cylindrical body, heating means M3 that heats an inside of the cylindrical body along the rotation axis direction, and a plurality of temperature measurement means M4 that measure temperatures of substantially a central portion of the cylindrical body along the rotation axis direction, and
in the second calcining step, a temperature is controlled with the heating means M3 such that a temperature C of a supply port P3 side of the second cylindrical body reaches a target temperature t3 selected from 600° C. to 800° C. and/or a maximum reached temperature D of the second cylindrical body reaches a target temperature t4 selected from 500° C. to 800° C.

The method for producing the catalyst according to any of [7] to [9], wherein the first cylindrical body and the second cylindrical body are rotary kilns.

The method for producing the catalyst according to any of [1] to [10], comprising:
a preparation step of preparing a precursor of the catalyst,
wherein, in the preparation step, ammonia water is added to a liquid mixture of a metal compound.

A catalyst that is used in a gas phase catalytic oxidation reaction or gas phase catalytic ammoxidation reaction of propane or isobutane, wherein:
the catalyst comprises catalyst particles each having a composite metal oxide and a support that supports the composite metal oxide,
the catalyst particles have a median diameter of 20 μm or more and 150 μm or less,
a shape of the catalyst particle is spherical, and
in a binarization processed image BP₂ obtained by performing a binarization process for classifying regions into a white region and a black region that are defined in the following <1> on a cross-sectional image showing the catalyst particles and having an area of 1200 μm² or more obtained by SEM backscattered electron image observation based on the following <0>, σ/A that is calculated in the following <2> satisfies 0.10 or more and 0.30 or less:
   <0> Acquisition Conditions for Cross-Sectional Image with SEM
accelerating voltage: 15 kV,
magnification: 700 times,
resolution: 512 dpi,
image size: 2560 pixels×1920 pixels, eight-bit depth,
brightness value of background other than catalyst particles: 0 to 40,
peak position of brightness value of portion of support: 70 to 140, and
brightness value of central portion of composite metal oxide region: 255,

### <1> Binarization Process

### [Acquisition of Image for Catalyst Analysis]

(i) a grayscale process is performed on the cross-sectional image of the catalyst,
(ii) a median filter process in which a kernel size is set to 9 pixels×9 pixels is performed on the image after the (i),
(iii) Otsu's binarization on the image after the (ii) is performed,
(iv) contour extraction is performed on the image after the (iii) based on a binarization result,
(v) on the image after the (iv), a process for whitening a region where the number of pixels in the contour is 250000 pixels or more and 750000 pixels or less is performed, a process for blackening a region outside the contour that is a region outside the region where the number of pixels in the contour is 250000 pixels or more and 750000 pixels or less is performed, and a binarization processed image BP₁ is acquired, and
(vi) a masking process on the image after the (i) is performed based on the blackened pixel information of the binarization processed image BP₁ acquired in the (v), and an image for catalyst analysis in which outer regions of contours of the catalyst particles are regarded as black regions and insides of the contours are regarded as catalyst particle regions is acquired,

### [Process for Specifying White Region Based on Image for Catalyst Analysis]

(vii) a median filter process in which a kernel size is set to 5 pixels×5 pixels is performed on the image for catalyst analysis obtained in the (vi), and
(viii) a binarization process in which a brightness value at which the number of pixels becomes a local minimum value in a brightness value range of 150 or more and 255 or less is defined as a threshold value is performed on the image after the (vii), insides of the catalyst particles are classified into white regions and black regions, and a binarization processed image BP₂ in which the white regions are specified is acquired,

### <2> σ/A Calculation

(I) in the binarization processed image BP₂ acquired in the <1>, an area C₀ of one arbitrary catalyst particle region and an area W₀ of the white region in the catalyst particle region are calculated,
(II) outermost edges E₀ that are vertically and horizontally adjacent to the one arbitrary catalyst particle region used in the (I) and are composed of each pixel unit are shaved, and an area C₁ of the remaining catalyst particle region and an area W₁ of the white region in the remaining catalyst particle region are calculated,
(III) a ratio F₀=(W₁−W₀)/(C₀−C₁) of the white region to the catalyst particle region in the outermost edges E, is calculated,
(IV) outermost edges E₁ that are vertically and horizontally adjacent to the remaining catalyst particle region in the (II) and are composed of each pixel unit are shaved, and an area C₂ of the remaining catalyst particle region and an area W₂ of the white region in the remaining catalyst particle region are calculated,
(V) a ratio F₁=(W₁−W₂)/(C₁−C₂) of the white region to the catalyst particle region in the outermost edges E₁ is calculated,
(VI) the same processes as the (IV) and the (V) are repeated until outermost edges Eₙ that make it impossible to shave outermost edges any longer are shaved, and Cₙ, Wₙ, and Fₙ are calculated,
where, Fₙ is represented by Fₙ=(Wₙ−Wₙ₊₁)/(Cₙ−Cₙ₊₁),
(VII) when a local maximum value among F₁ to Fₙ is represented by Fₖ (0≤k≤n), a distance Dₖ from a surface of the catalyst particle to an outermost edge Eₖ indicating the local maximum value is defined as Dₖ=0.14*(k+1)−0.07, and Dₖ is calculated,
(VIII) operations of the (I) to (VI) are performed on 20 arbitrary and different catalyst particle regions that are obtained from the binarization processed image BP₂, and 20 Dₖ's corresponding to the individual catalyst particle regions are obtained, and
(IX) an average of the 20 Dₖ's obtained in the (VIII) is represented by A, a sample standard deviation of the 20 Dₖ's is represented by σ, and σ/A is calculated.

The catalyst according to [12], wherein, in the SEM backscattered electron image observation, a ratio B/C of a total value B of white metal oxide regions having an area of 5000 nm² or more on a catalyst cross section to a total area C of cross sections of the catalyst particles is 13% or less.

The catalyst according to [12] or [13], wherein the composite metal oxide satisfies the following composition formula:

Mo₁VₐSb_{b}Nb_{c}T_{d}ZₑOₙ
(in the formula, T represents at least one element selected from Ti, W, Mn, and Bi, Z represents at least one element selected from La, Ce, Yb, and Y, a, b, c, d, or e is an atomic ratio of each element when Mo is regarded as one and is each in a range of 0.05≤a≤0.35, 0.05≤b≤0.35, 0.01≤c≤0.15, 0≤d≤0.10, or 0≤e≤0.10, and n is a value satisfying a balance of a valence).

### Advantageous Effect of Invention

According to the present invention, it is possible to provide a catalyst and a method for producing a catalyst that enable the highly efficient use of ammonia and the production of acrylonitrile at a high yield.

### BRIEF DESCRIPTION OF DRAWINGS

FIG. 1 shows a schematic view partially showing one example of a production device for producing the catalyst of the present embodiment.

FIG. 2 shows an explanatory view schematically showing one example of a first cylindrical body in the production device for producing the catalyst of the present embodiment.

FIG. 3 shows an explanatory view schematically showing one example of a second cylindrical body in the production device for producing the catalyst of the present embodiment.

FIG. 4 shows an example of a cross-sectional SEM photograph of Example 2.

FIG. 5 shows an image of a histogram in which brightness values are indicated along the horizontal axis and the numbers of pixels are indicated along the vertical axis, the histogram being drawn regarding an image obtained by performing a median filter process in which the kernel size is set to 5 pixels×5 pixels on an image for catalyst analysis.

FIG. 6 shows an image of a process for shaving outermost edges.

FIG. 7 shows a graph of the distance from the catalyst surface layer and the area ratio of metal oxide regions regarding 20 catalyst particles that are regarded as a measurement target in Example 2.

FIG. 8 shows an explanatory view of a position A corresponding to a temperature A in examples.

### DESCRIPTION OF EMBODIMENTS

Hereinafter, an embodiment for carrying out the present invention (hereinafter, simply referred to as “present embodiment”) will be described, but the present invention is not limited to the following embodiment and can be modified in a variety of manners within the scope of the gist thereof.

### <<Catalyst>>

A catalyst of the present embodiment is a catalyst that is used in the gas phase catalytic oxidation reaction or gas phase catalytic ammoxidation reaction of propane or isobutane, the catalyst contains catalyst particles each having a composite metal oxide and a support that supports the composite metal oxide, the catalyst particles have a median diameter of 20 μm or more and 150 μm or less, and the shape of the catalyst particle is spherical. Furthermore, in the catalyst of the present embodiment, σ/A that is calculated in the following <2> satisfies 0.10 or more and 0.30 or less in a binarization processed image BP₂ obtained by performing a binarization process for classifying regions into a white region and a black region that are defined in the following <1> on a cross-sectional image showing the catalyst particles and having an area of 1200 μm² or more obtained by SEM (scanning electron microscope) backscattered electron image observation based on the following <0>.
<0> Acquisition conditions for cross-sectional image with SEM
   Accelerating voltage: 15 kV
   Magnification: 700 times
   Resolution: 512 dpi
   Image size: 2560 pixels×1920 pixels, eight-bit depth
   Brightness value of background other than catalyst particles: 0 to 40
   Peak position of brightness value of portion of support: 70 to 140
   Brightness value of central portion of composite metal oxide region: 255
<1> Binarization process

### [Acquisition of Image for Catalyst Analysis]

(i) A grayscale process is performed on the cross-sectional image of the catalyst.
(ii) A median filter process in which the kernel size is set to 9 pixels×9 pixels is performed on the image after the (i).
(iii) Otsu's binarization on the image after the (ii) is performed.
(iv) Contour extraction is performed on the image after the (iii) based on the binarization result.
(v) On the image after the (iv), a process for whitening a region where the number of pixels in the contour is 250000 pixels or more and 750000 pixels or less is performed, a process for blackening a region outside the contour that is a region outside the region where the number of pixels in the contour is 250000 pixels or more and 750000 pixels or less is performed, and a binarization processed image BP₁ is acquired.
(vi) A masking process on the image after the (i) is performed based on the blackened pixel information of the binarization processed image BP₁ acquired in the (v), and an image for catalyst analysis in which outer regions of the contours of the catalyst particles are regarded as black regions and the insides of the contours are regarded as catalyst particle regions is acquired.

### [Process for Specifying White Region Based on Image for Catalyst Analysis]

(vii) A median filter process in which the kernel size is set to 5 pixels×5 pixels is performed on the image for catalyst analysis obtained in the (vi).
(viii) A binarization process in which a brightness value at which the number of pixels becomes the local minimum value in a brightness value range of 150 or more and 255 or less is defined as a threshold value is performed on the image after the (vii), the insides of the catalyst particles are classified into white regions and black regions, and a binarization processed image BP₂ in which the white regions are specified is acquired.
<2> σ/A Calculation
   (I) In the binarization processed image BP₂ acquired in the <1>, the area C₀ of one arbitrary catalyst particle region and the area W₀ of the white region in the catalyst particle region are calculated.
   (II) Outermost edges E, that are vertically and horizontally adjacent to the one arbitrary catalyst particle region used in the (I) and are composed of each pixel unit are shaved, and the area C₁ of the remaining catalyst particle region and the area W₁ of the white region in the remaining catalyst particle region are calculated.
   (III) a ratio F₀=(W₁−W₀)/(C₀−C₁) of the white region to the catalyst particle region in the outermost edges E₀ is calculated.
   (IV) Outermost edges E₁ that are vertically and horizontally adjacent to the remaining catalyst particle region in the (II) and are composed of each pixel unit are shaved, and the area C₂ of the remaining catalyst particle region and the area W₂ of the white region in the remaining catalyst particle region are calculated.
   (V) The ratio F₁=(W₁−W₂)/(C₁−C₂) of the white region to the catalyst particle region in the outermost edges E₁ is calculated.
   (VI) The same processes as the (IV) and the (V) are repeated until outermost edges Eₙ that make it impossible to shave outermost edges any longer are shaved, and Cₙ, Wₙ, and Fₙ are calculated, where Fₙ is represented by Fₙ=(Wₙ−Wₙ₊₁)/(Cₙ−Cₙ₊₁).
   (VII) When the local maximum value among F₁ to Fₙ is represented by Fₖ (0≤k≤n), a distance Dₖ from the surface of the catalyst particle to an outermost edge Eₖ indicating the local maximum value is defined as Dₖ=0.14*(k+1)−0.07, and Dₖ is calculated.
   (VIII) The operations of the (I) to (VI) are performed on 20 arbitrary and different catalyst particle regions that are obtained from the binarization processed image BP₂, and 20 Dₖ's corresponding to the individual catalyst particle regions are obtained.
   (IX) The average of the 20 Dₖ's obtained in the (VIII) is represented by A, the sample standard deviation of the 20 D's is represented by σ, and σ/A is calculated.

The catalyst of the present embodiment is composed as described above and thus enables the highly efficient use of ammonia and the production of acrylonitrile at a high yield. The catalyst of the present embodiment typically enables the highly efficient use of ammonia and the economical production of acrylonitrile by reduction in the output level.

Described below is how the present inventors have designed the catalyst of the present embodiment having the above-described performance. However, this does not mean to limit the mechanism of how the present embodiment works to the following contents.

First, the present inventors found that there was a variation in the degree or distribution of the growth of a specific crystal phase in catalyst particles as a result of observing catalysts for an ammoxidation reaction obtained by conventional methods (hereinafter, simply referred to as “conventional catalysts”) with SEM, and studied a homogenization method and also an index for evaluating the homogeneity of the specific crystal phase (hereinafter, also simply referred to as “homogeneity”) with an expectation of the catalyst performance being further improved by the homogenization.

In the catalyst of the present embodiment, a composite metal oxide has dispersed in the particles. As the distribution of the crystal of the composite oxide in the catalyst particles becomes more uniform per catalyst particle, the catalyst can be said to be more homogeneous as a bulk and have a higher quality. Here, the homogeneity is defined as no bias in the distribution of the composite oxide crystals per catalyst particle. Generally, homogeneous catalysts tend to have high performance and be capable of efficiently generating desired products. The distribution of the composite oxide crystal in the catalyst particle can be evaluated by observing a cross-sectional image of the catalyst.

The cross-sectional image of the catalyst is acquired by the observation of a backscattered electron image based on the conditions described in the <0>, such as an accelerating voltage being set to 15 kV, using SEM. That is, backscattered electron image observation at the above-described accelerating voltage makes it easy to discriminate a supported portion and a metal crystal portion due to a difference in the composition. At that time, the contrast is adjusted such that the brightness value of the background other than the catalyst portion reaches near zero, the average value of the brightness values of catalyst-supported portions reaches approximately 70 to 140 (preferably approximately 80 to 120), and the brightness value of the central portion of a metal oxide region reaches near 255. In the present embodiment, a cross-sectional image including the catalyst particles having an area of 1200 μm² or more is acquired, and a cross-sectional image including the catalyst particles having an area of 1200 μm² or more and 12000 μm² or less is preferably acquired. A method for obtaining a sample for cross-sectional observation is not particularly limited, and it is ordinary to implant the catalyst in a resin and cut out a cross section by polishing using an ion beam (FIB), ion milling, or a file such that the cross section of the catalyst particle can be observed. For the subsequent image analysis through the calculation of σ/A, the <1> and the <2> are followed.

As a result of the studies, for the conventional catalysts, the numerical values of σ/A that is calculated in the <2> tended to fall within a certain range in a binarization processed image BP₂ obtained by performing a binarization process for classifying regions into a white region and a black region that are defined in the <1>, and the present inventors assumed that the above-described homogeneity can be achieved by seeking a range different therefrom. That is, with a knowledge that the white regions are regions in the catalyst particle that contribute particularly to the catalyst performance and the catalyst performance significantly improves when the regions are present at a uniform distance from the surface of the catalyst, it was found that, particularly when the numerical value of σ/A (coefficient of variation) is adjusted to a specific range, a catalyst is made to enable the highly efficient use of ammonia and the economical production of acrylonitrile by reduction in the output level. The coefficient of variation σ/A is an ordinary statistical index, and it can be said that the variation becomes smaller as the value becomes smaller. As a result of analyzing the conventional catalysts, the present inventors have clarified that the coefficients of variation σ/A thereof became values exceeding 0.3.

From the above-described viewpoint, in the catalyst of the present embodiment, when σ/A is 0.10 or more and 0.30 or less, the catalyst can be homogeneously calcined with no unevenness, and consequently, the highly efficient use of ammonia and the economical production of acrylonitrile by reduction in the output level are possible. From the same viewpoint, σ/A is preferably 0.10 or more and 0.20 or less and more preferably 0.15 or less.

The σ/A can be measured by, specifically, a method to be described in examples to be described below.

In addition, σ/A can be adjusted to be within the above-described range by, for example, producing the catalyst by a method for producing a catalyst to be described below (the suppression of a temperature variation at a predetermined position in a production device).

The value of σ/A can also be reduced to less than 0.10 by highly controlling the temperature variation or the like, and from such a viewpoint, the value of σ/A may be 0 or more and 0.30 or less, may be 0 or more and 0.20 or less, or may be 0 or more and 0.15 or less. Incidentally, in the present embodiment, from the viewpoint of the economic efficiency such as avoidance of an excess facility being disposed in a production device to be described below, σ/A is set to 0.10 or more and 0.30 or less and is preferably 0.10 or more and 0.20 or less and more preferably 0.15 or less. From the same viewpoint as described above, σ/A can be set to 0.122 or more and 0.30 or less and can also be set to 0.122 or more and 0.20 or less.

In the catalyst of the present embodiment, in the SEM backscattered electron image observation, the ratio B/C of the total value B of white metal oxide regions having an area of 5000 nm² or more on the catalyst cross section to the total area C of the cross sections of the catalyst particles is preferably 13% or less, more preferably 12.5% or less, and still more preferably 12.0% or less from the viewpoint of the homogeneity. On the other hand, the lower limit is normally more than 0%, preferably 1% or more, and more preferably 5% or more.

The B/C can be measured by, specifically, a method to be described in examples to be described below.

In addition, the B/C can be adjusted to be within the above-described range by, for example, producing the catalyst by a method for producing a catalyst to be described below.

### (Composite Metal Oxide)

In the present embodiment, the catalyst particle has a composite metal oxide supported by a support. The composite metal oxide in the present embodiment is not particularly limited, but preferably contains molybdenum (Mo), vanadium (V), antimony (Sb), and niobium (Nb) as a metal and may contain a different metal as necessary. In the present embodiment, the composite metal oxide preferably satisfies the following composition formula from the viewpoint of the catalyst performance.

Mo₁VₐSb_{b}Nb_{c}T_{d}ZₑOₙ
(in the formula, T represents at least one element selected from Ti, W, Mn, and Bi, Z represents at least one element selected from La, Ce, Yb, and Y, a, b, c, d, or e is an atomic ratio of each element when Mo is regarded as one and is each in a range of 0.05≤a≤0.35, 0.05≤b≤0.35, 0.01≤c≤0.15, 0≤d≤0.10, or 0≤e≤0.10, and n is a value satisfying a balance of a valence).

In the present embodiment, the catalyst particle has a support that supports the composite metal oxide. As the support, a silica support is preferable. The silica support is not particularly limited as long as supports contain silica, and examples of the starting material include silica sol (also referred to as colloidal silica), powdery silica (dry silica), and the like. In the present embodiment, from the viewpoint of the wear resistance and strength of the catalyst particle, the ratio of the mass of the silica support to the total amount (100 mass %) of the catalyst is preferably 30 mass % or more and 70 mass % or less and more preferably 40 to 60 mass % in terms of SiO₂.

### (Particle Shape)

The catalyst of the present embodiment contains the catalyst particles having a spherical shape. In the present embodiment, the catalyst particles being spherical can be confirmed from, for example, the circularity of an arbitrary cross section of the catalyst particle. Being circular means that the circularity is 0.95 or more.

### (Median Diameter)

In the present embodiment, the median diameter of the catalyst particles is not particularly limited, but is preferably 20 μm or more and 150 μm or less, more preferably 30 μm or more and 100 μm or less, and still more preferably 40 μm or more and 70 μm or less from the viewpoint of the catalyst performance.

The median diameter can be measured by, specifically, a method to be described in examples to be described below.

In addition, the median diameter can be adjusted to be within the above-described range by, for example, producing the catalyst by a method for producing a catalyst to be described below. Specifically, the median diameter can be adjusted to be within the above-described range by appropriately adjusting the spraying rate, the rate of the transportation of a starting material-compounded solution, the rotation speed of an atomizer in the case of a centrifugal method, or the like in a drying step to be described below.

### <<Method for Producing Catalyst>>

A method for producing the catalyst of the present embodiment is not particularly limited as long as the configuration of the catalyst of the present embodiment can be obtained, but the catalyst can be more preferably obtained by a method to be described below.

That is, the method for producing a catalyst of the present embodiment (hereinafter, also referred to as “the method of the present embodiment”) is a method for producing a catalyst that is used in a gas phase catalytic oxidation reaction or gas phase catalytic ammoxidation reaction of propane or isobutane, the method having a drying step of drying a precursor of the catalyst to obtain dry particles, a first supplying step of supplying the dry particles to a first cylindrical body, and a first calcining step of calcining the dry particles supplied to the first cylindrical body to obtain first calcined particle, in which the first cylindrical body has a supply port P1 that supplies the dry particles into a cylindrical body at one end T1 side of the cylindrical body in a rotation axis direction, a carry-out port P2 that carries out the calcined particles to the outside of the cylindrical body at the other end T2 side in the rotation axis direction, and heating means M1 that heats the inside of the cylindrical body along the rotation axis direction, and a variation range of a temperature A on the supply port P1 side in the first cylindrical body is 10° C. or less.

The production method of the present embodiment is composed as described above and is thus capable of producing a catalyst that enables the highly efficient use of ammonia and the production of acrylonitrile at a high yield. According to the production method of the present embodiment, typically, it is possible to produce a catalyst that enables the highly efficient use of ammonia and the economical production of acrylonitrile by reduction in the output level.

In the production method of the present embodiment, a method for transporting the dry particles is not limited to the following and may be gas transportation, and examples thereof include a method in which the dry particles are made to naturally drop by providing a hopper or the like above a calcining machine to be described below and the like. In the production method of the present embodiment, the dry particles are preferably supplied to the supply port P1 by gas transportation in the first supplying step from the viewpoint of the easiness in temperature control.

In the production method of the present embodiment, from the same viewpoint as described above, it is preferable that the first cylindrical body further has a plurality of temperature measurement means M2 that measure the temperatures of substantially the central portion of the cylindrical body along the rotation axis direction of the cylindrical body in the cylindrical body, a temperature A is measured with, among the temperature measurement means M2, temperature measurement means M2′ that is disposed on the supply port P1 side, and the temperature A is adjusted by controlling the temperature of a gas that is used for the gas transportation.

As described above, in the production method of the present embodiment, it is preferable that the first cylindrical body further has the plurality of temperature measurement means M2 that measure the temperatures of substantially the central portion of the cylindrical body along the rotation axis direction of the cylindrical body in the cylindrical body, in the first supplying step, the dry particles are supplied to the supply port P1 by gas transportation, the temperature A is measured with, among the temperature measurement means M2, the temperature measurement means M2′ disposed on the supply port P1 side, and the temperature A is adjusted by controlling the temperature of the gas that is used for the gas transportation.

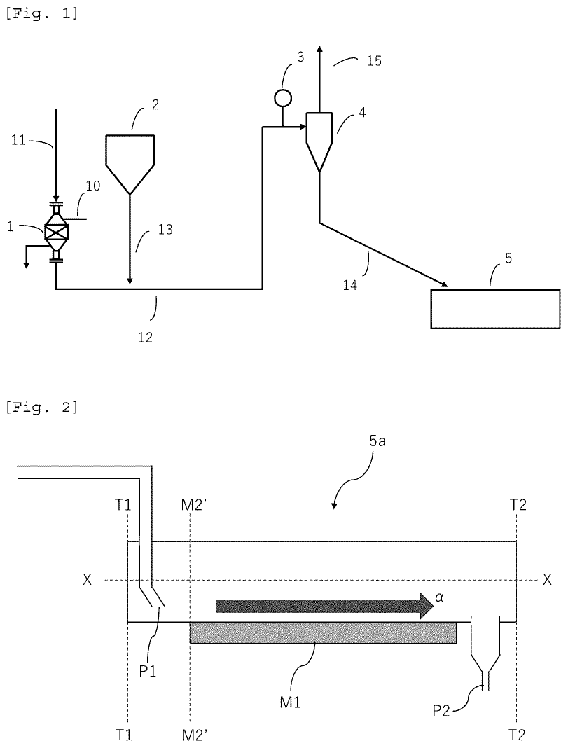

A production device for performing the production method of the present embodiment is not particularly limited, and for example, a device as shown in FIG. 1 can be employed.

In the example of FIG. 1, the dry particles can be stored in a storage container 2. In the example of FIG. 1, the dry particles stored in the storage container 2 are circulated in a pipe 13 and joined with an inert gas that is a transportation medium. That is, the dry particles are suctioned with an inert gas that is circulated in a pipe 12 from a pipe 11 through a heat exchanger 1, moved to a dry particle collection machine 4 through a temperature measurement point 4 and then transported to a calcining machine 5 from a pipe 14. Here, the collection machine 4 is not limited to the following and may be, for example, a centrifugal cyclone, and at this time, the collection machine may be configured such that some of the inert gas that is used for the gas transportation reaches the calcining machine from the pipe 14 and the remainder of the inert gas is separated from the dry particles in the cyclone and discharged to the outside of the system from a pipe 15. In the case of having such a configuration, while not limited to the following, the production device may be configured such that, for example, the dry particles that move from the collection machine 4 to the calcining machine 5 can be smoothly transported by a driving force derived from the centrifugal force of the cyclone and/or the slope of the pipe 14. The calcining machine 5 includes the first cylindrical body and may further include a second cylindrical body.

The heat exchanger 1 is a heat exchanger that heats the inert gas by heat exchange with a heat medium. The heat medium (for example, water, benzyl alcohol, ethylene glycol, toluene, and silicone oil) is circulated in the tube of a pipe 10, and the temperature of the inert gas that is circulated from the pipe 11 through the heat exchanger 1 can be adjusted by adjusting the temperature and circulation amount of the heat medium. The configuration of the heat exchanger 1 is not particularly limited, and a well-known heat exchanger may be used.

The temperature of the dry particles moving toward the calcining machine 5 is measured over time at the temperature measurement point 3, and the temperature of the inert gas is adjusted in the heat exchanger 1 based on the change of the temperature over time that is observed by the measurement such that a variation in the injection temperature is suppressed.

In order to prevent the temperatures of the heated inert gas and the dry particles from being affected by an external air, a heat insulation process is preferably performed on the pipe 12, the pipe 14, and the dry particle collection machine 4. A method for the heat insulation process is not particularly limited, and a well-known method such as the installation of a jacket for heat exchange by the circulation of a heat medium can be employed as appropriate.

In the production method of the present embodiment, as long as the drying step, the first supplying step, and the first calcining step, which have been described above, are performed, the rest steps are not particularly limited. That is, the production method of the present embodiment is not limited to the device configuration or operation and the like until the dry particles reach the calcining machine 5, which are exemplified in FIG. 1.

The transportation time during which the dry particles come out of the storage container 2 and then reaches the calcining machine 5 through the pipe 12, the dry particle collection device 4, and the pipe 14 is preferably 0 seconds or longer and 600 seconds or shorter.

When the temperature variation range of the dry particles that is measured at the temperature measurement point 3 is adjusted to be preferably 0° C. to 15° C. and more preferably 0° C. to 5° C., there is a tendency that it becomes easy to maintain the temperature of the calcining machine constant and the catalyst can be homogeneously calcined.

The temperature of the dry particles that is observed at the temperature measurement point 3 is preferably 30° C. to 70° C. and more preferably 45° C. to 55° C. from the viewpoint of preventing the pyrolysis thereof in advance. The temperature becomes substantially the same as the temperature of the gas that moves in the pipe 14.

As described above, the production method of the present embodiment has the drying step of drying the precursor of the catalyst to obtain dry particles, the first supplying step of supplying the dry particles to the first cylindrical body, and the first calcining step of calcining the dry particles supplied to the first cylindrical body to obtain the first calcined particle and may have a preparation step to be described below ahead of the drying step. In addition, a second calcining step to be described below may be included after the first calcining step, and separately, a projection removal step to be described below may also be included. Hereinafter, each step will be described.

### (Drying Step)

In the drying step, the precursor of the catalyst is dried to obtain dry particles. In the drying step in the present embodiment, typically, dry particles can be obtained by subjecting a precursor slurry of the catalyst to spray drying. The drying step or calcining, which will be described below, in the present embodiment is typically performed in a continuous manner. However, it is also possible to intermittently perform a part of each step to an extent that a skilled person in the art understands (typically, to an extent that the catalyst of the present embodiment can be obtained) if the effect of the present embodiment is not impaired. A drying method is not particularly limited, and the precursor can be dried by a variety of well-known methods such as spray drying.

In the present embodiment, atomization in the spray drying can be performed by a centrifugal method, a two-fluid nozzle method, or a high-pressure nozzle method. As a drying heat source, an air heated with steam, an electric heater or the like can be used. The inlet temperature of the dryer in a spray drying machine is preferably 150° C. to 300° C., and the outlet temperature of the dryer is preferably 100° C. to 160° C.

### (First Supplying Step and First Calcining Step)

In the first supplying step, the dry particles are supplied to the first cylindrical body. Next, in the first calcining step, the dry particles supplied to the first cylindrical are calcined to obtain first calcined particles.

The dry particles obtained in the drying step can be stored in, for example, a storage container or the like having an arbitrary configuration that is provided in the first supplying step, which is not limited thereto.

In the present embodiment, the first cylindrical body functions as a calcining machine, and calcining is performed in a cylindrical body thereof. As the first cylindrical body in the present embodiment, typically, a cylindrical body that is rotatable around an axis can be employed. One example of the first cylindrical body is shown in FIG. 2. A first cylindrical body 5a has a supply port P1 that guides (supplies) the dry particles into the cylindrical body on a T1 side between one end T1 and the other end T2 in a rotation axis XX direction of the cylindrical body. The position of the supply port P1 is not particularly limited, but the supply port needs to be disposed such that the distance to T1 becomes shorter than the distance to T2 in the rotation axis XX direction, and the positions of T1 and P1 may match each other in the rotation axis XX direction. The shape of the pipe 14 to the supply port P1 is shown as in FIG. 2 for the convenience of description, which does not mean to limit the shape to such a shape, and a variety of shapes such as a shape that is consistent to the shape shown in FIG. 1 can be employed.

In addition, the first cylindrical body 5a has a carry-out port P2 that carries out the calcined particles to the outside of the cylindrical body on the other end T2 side in the rotation axis XX direction. The position of the carry-out port P2 is not particularly limited, but the carry-out port needs to be disposed such that the distance to T2 becomes shorter than the distance to T1 in the rotation axis XX direction, and the positions of T2 and P2 may match each other in the rotation axis XX direction.

Furthermore, the first cylindrical body 5a has heating means M1 that heats the inside of the cylindrical body along the rotation axis XX direction. Still furthermore, the first cylindrical body 5a has a plurality of temperature measurement means M2 that measure the temperatures of substantially the central portion along the rotation axis XX direction in the cylindrical body.

As shown in FIG. 2, the dry particles move from the P1 side toward the P2 side (in an arrow & direction) and are calcined by being heated with the heating means M1 disposed at a position corresponding thereto. In the example shown in FIG. 2, the heating means M1 (which may be single heating means or a plurality of heating means may be continuously disposed) is disposed to extend from the P1 side toward the P2 side, that is, the heating means M1 is disposed at a position excluding the one end T1 and the other end T2, but the position thereof is not limited thereto, and the heating means M1 may extend in a position including the one end T1 through the other end T2, that is, the heating means may be configured such that calcining is performed in the entire first cylindrical body 5a. Here, the space from the one end T1 through the supply port P1 in FIG. 2 is also made to reach a high temperature with the heating means M1, and the dry particles supplied to the first cylindrical body 5a are thus heated immediately even before reaching the position corresponding to the heating means M1.

In the first supplying step, the variation range of the temperature A on the supply port P1 side in the first cylindrical body is 10° C. or less. A method for measuring the temperature A on the supply port P1 side can be set as appropriate in consideration of the configuration, size or the like of a production device being used and is not particularly limited, and the temperature A can be measured by a method to be described below.

In the first supplying step, in a case where the first cylindrical body further has the plurality of temperature measurement means M2 that measure the temperatures of substantially the central portion of the cylindrical body along the rotation axis direction of the cylindrical body in the cylindrical body and the dry particles are supplied to the supply port P1 by gas transportation, typically, in the first calcining step, the temperature A can be measured with, among the temperature measurement means M2, the temperature measurement means M2′ disposed on the supply port P1 side, and here, the temperature of a gas that is used for the gas transportation can be controlled such that the variation range between the maximum value and the minimum value of the temperature A being measured becomes 10° C. or less. As the position of the temperature measurement means M2′, an arbitrary position on the supply port P1 side in the first cylindrical body can be set, and typically, the temperature measurement means M2′ can be disposed such that, for example, the distance to the supply port P1 becomes shorter than the distance to the carry-out port P2 in the rotation axis direction of the first cylindrical body. The temperature measurement means M2′ may be temperature measurement means least distant from the supply port P1 among the temperature measurement means M2. Regarding “temperature measurement means least distant from the supply port P1”, the exact position thereof is not limited as long as the temperature measurement means is intended to directly measure the temperature at “temperature measurement point least distant from the supply port P1.” In the present embodiment, in more detail, the position of the temperature measurement means M2′ can be set to the measurement position described in the examples to be described below.

In the production method of the present embodiment, a period of time for holding the variation range of the temperature A can be set as appropriate in consideration of a desired amount of a catalyst or the like and is not particularly limited. For example, the variation range may be 10° C. or less for 12 hours or longer, the variation range may be 10° C. or less for 24 hours or longer, or the variation range may be 10° C. or less for 120 hours or longer.

The background that made the present inventors establish the production method of the present embodiment will be described below. However, this does not mean to limit the action mechanism in the present embodiment to the following contents.

As described above, the present inventors found that there was a variation in the degree or distribution of the growth of a specific crystal phase in catalyst particles as a result of observing the conventional catalysts with SEM, studied a homogenization method with an expectation of the catalyst performance being further improved by achieving the homogenization thereof, found that white regions are regions in the catalyst particle that contribute particularly to the catalyst performance and the catalyst performance significantly improves when the regions are present at a uniform distance from the surface of the catalyst. Here, the generation and growth of the white regions are affected by the reduction status of the catalyst, the reduction status of the catalyst depends on temperatures, and it was thus assumed that the presence distances of the white regions from the surface of the catalyst is made to be uniform by suppressing a temperature variation in a step that is likely to affect the reduction status in the catalyst production steps. That is, it can be considered that, when all particles receive the same thermal history in a calcining step, the degrees of reduction become substantially the same, the generation and growth statuses of white regions in the resulting catalyst particles also become substantially the same, and consequently, the presence distances of the white regions in the catalyst particles become substantially the same. As a result of repeating additional studies from such a viewpoint, the present inventors found that a temperature variation near the inlet of the calcining machine (a temperature variation on the supply port P1 side in the first cylindrical body) is dominant as a factor that affects temperature variations during calcining.

From the above-described viewpoint, in the present embodiment, the variation range of the temperature that is measured with the temperature measurement means M2′ is preferably made to be within a predetermined range, and the variation range is preferably controlled with the temperature of the gas that is used for the gas transportation.

From the viewpoint of making it easy to adjust the degree of reduction of the catalyst, an inert gas is preferably used in the gas transportation in the present embodiment. The inert gas is not particularly limited, and for example, a noble gas such as nitrogen or argon can be used.

In addition, the amount of the inert gas supplied is not particularly limited, but is preferably 1 NL/min or more, more preferably 3 NL/min or more and 100 NL/min or less, and still more preferably 5 NL/min or more and 80 NL/min or less per 1 kg/hr of the supply rate of the dry particle to the supply port P1 from the viewpoint of making it easy to adjust the degree of reduction of the catalyst.

In addition, the temperature of the inert gas is not particularly limited, but is preferably 0° C. or higher and 100° C. or lower, more preferably 20° C. or higher and 80° C. or lower, and still more preferably 30° C. or higher and 80° C. or lower from the viewpoint of making it easy to adjust the degree of reduction of the catalyst.

In the present embodiment, from the viewpoint of holding the oxygen concentration in the first cylindrical body to be low and the viewpoint of adjusting the redox degree, a second gas that does not get involved in the gas transportation can be directly supplied to the first cylindrical body. As the second gas, an inert gas is preferably used from the viewpoint of making it easy to adjust the degree of reduction of the catalyst. Such an inert gas is not particularly limited, and for example, a noble gas such as nitrogen or argon can be used. The second gas may be the same as or different from the gas that is used for the gas transportation. In the example shown in FIG. 1, the gas that is used for the gas transportation is supplied to the calcining machine 5 through the pipe 14, but the second gas is passed through a pipe, not shown, connected to the calcining machine 5 and supplied to the calcining machine 5. The amount of the second gas supplied is not particularly limited, but is preferably 5 NL/min or more and 100 NL/min or less, more preferably 10 NL/min or more and 90 NL/min or less, and still more preferably 20 NL/min or more and 80 NL/min or less per 1 kg/hr of the supply rate of the dry particle to the supply port P1 from the viewpoint of making it easy to adjust the degree of reduction of the catalyst.

The supply rate of the dry particles to the supply port P1 is not particularly limited, but is preferably 0.1 kg/hr or higher and 100 kg/hr or lower, more preferably 0.2 kg/hr or higher and 70 kg/hr or lower, and still more preferably 0.3 kg/hr or higher and 50 kg/hr or lower per cubic meter of the volume of the first cylindrical body from the viewpoint of making it easy to adjust the degree of reduction of the catalyst. While not limited to the following, the supply rate can be obtained by, for example, confirming the amount of the first calcined particles that are discharged from the supply port P2.

In the first calcining step, from the viewpoint of making it easy to adjust the degree of reduction of the catalyst, it is preferable to control temperatures with the heating means M1 such that the temperature A reaches a target temperature t1 selected from 100° C. to 300° C. and/or a temperature B on the carry-out port P2 side of the first cylindrical body reaches a target temperature t2 selected from 350° C. to 500° C.

Temperature measurement means M2″ for measuring the temperature B is not particularly limited as long as the temperature measurement means M2″ is disposed such that the distance to the carry-out port P2 becomes shorter than the distance to the supply port P1 in the rotation axis direction of the first cylindrical body. Typically, the temperature measurement means M2″ can be said to be temperature measurement means least distant from the carry-out port P2 among the temperature measurement means M2.

More specific description will be given using the example of FIG. 2. For the dry particles supplied to the first cylindrical body 5a, it is preferable to control the temperature such that the temperature A that is measured with the temperature measurement means M2′ matches the target temperature t1, and here, the target temperature t1 is preferably selected from 100° C. to 300° C., more preferably selected from 120° C. to 280° C., and still more preferably selected from 150° C. to 250° C. In addition, for the dry particles that moves in the arrow α direction, it is preferable to control the temperature such that the temperature B that is measured with the temperature measurement means M2″ matches the target temperature t2, and here, the target temperature t2 is preferably selected from 300° C. to 500° C. and more preferably selected from 350° C. to 450° C.

The heating pattern from the target temperature t1 to the target temperature t2 is not particularly limited, and the temperature may be linearly increased or the temperature may be increased in an arc shape that is convex upward or downward. At the time of increasing the temperature from the target temperature t1 to the target temperature t2, there may be a variation in which the temperature temporarily decreases or the temperature further increases after reaching the target temperature t2, but the target temperature t2 is preferably held for 30 minutes or longer and more preferably held for three or 12 hours.

In the present embodiment, it is preferable that the spray drying of the precursor is performed in the drying step, the dry particles are continuously supplied in the first supplying step, and the dry particles are continuously calcined and the maximum reached temperature is 350° C. to 500° C. in the first calcining step from the viewpoint of making it easy to adjust the degree of reduction of the catalyst.

### (Second Supplying Step and Second Calcining Step)

The production method of the present embodiment preferably further has a second supplying step of supplying the first calcined particles to the second cylindrical body and a second calcining step of calcining the first calcined particles supplied to the second cylindrical body to obtain second calcined particles from the viewpoint of making it easy to adjust the degree of reduction of the catalyst. As the second cylindrical body as well, typically, a cylindrical body that is rotatable around an axis can be employed.

That is, the second cylindrical body functions as a calcining machine, and calcining is performed in a cylindrical body thereof. In more detail, in this case, the first cylindrical body functions as a calcining machine in the first stage, and the first stage of calcining is performed in the cylindrical body thereof. In contrast, the second cylindrical body functions as a calcining machine in the second stage, and the second stage of calcining is performed in the cylindrical body thereof.

In the present embodiment, it is preferable that the first calcined particles are continuously supplied in the second supplying step, and the first calcined particles are continuously calcined and the maximum reached temperature is 600° C. to 800° C. in the second calcining step from the viewpoint of making it easy to adjust the degree of reduction of the catalyst.

A preferable second cylindrical body that can be used in the present embodiment has a supply port P3 that guides (supplies) the first calcined particles into a cylindrical body at one end T3 in a rotation axis direction of the cylindrical body. In addition, the second cylindrical body has a carry-out port P4 that carries out the first calcined particles at the other end T4 in the rotation axis direction. Furthermore, the second cylindrical body has heating means M3 that heats the inside of the cylindrical body along the rotation axis direction. Still furthermore, the second cylindrical body has a plurality of temperature measurement means M4 that measure the temperatures of substantially the central portion of the cylindrical body along the rotation axis direction.

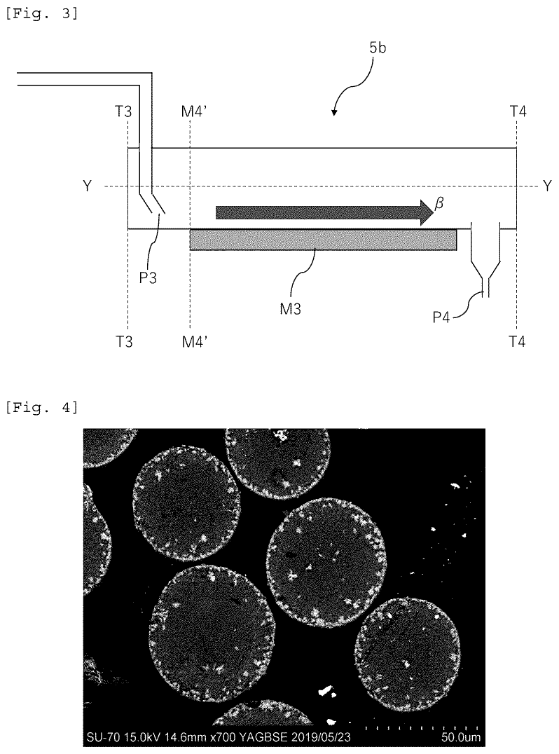

One example of the second cylindrical body is shown in FIG. 3. In the same figure, the second cylindrical is exemplified to have the same shape or configuration as the first cylindrical body, but the shape or configuration of the second cylindrical body may be the same as or different from those of the first cylindrical body.

A second cylindrical body 5b has a supply port P3 that guides (supplies) the first calcined particles into the cylindrical body on a T3 side between one end T3 and the other end T4 in a rotation axis YY direction of the cylindrical body. The position of the supply port P3 is not particularly limited, but the supply port needs to be disposed such that the distance to T3 becomes shorter than the distance to T4 in the rotation axis YY direction, and the positions of T3 and P3 may match each other in the rotation axis YY direction. The shape of the pipe to the supply port P3 is shown as in FIG. 3 for the convenience of description, which does not mean to limit the shape to such a shape, and a variety of shapes such as a shape that is consistent to the shape shown in FIG. 1 can be employed.

In addition, the second cylindrical body 5b has a carry-out port P4 that carries out the first calcined particles to the outside of the cylindrical body on the other end T4 side in the rotation axis YY direction. The position of the carry-out port P4 is not particularly limited, but the carry-out port needs to be disposed such that the distance to T4 becomes shorter than the distance to T3 in the rotation axis YY direction, and the positions of T4 and P4 may match each other in the rotation axis YY direction.

Furthermore, the second cylindrical body 5b has heating means M3 that heats the inside of the cylindrical body along the rotation axis YY direction. Furthermore, the second cylindrical body 5b has a plurality of temperature measurement means M4 that measure the temperatures of substantially the central portion along the rotation axis YY direction in the cylindrical body.

As shown in FIG. 3, the first calcined particles move from the P3 side toward the P4 side (in an arrow β direction) and are calcined by being heated with the heating means M3 disposed at a position corresponding thereto. In the example shown in FIG. 2, the heating means M3 (which may be single heating means or a plurality of heating means may be continuously disposed) is disposed to extend from the P3 side toward the P4 side, that is, the heating means M3 is disposed at a position excluding the one end T3 and the other end T4, but the position thereof is not limited thereto, and the heating means M3 may extend in a position including the one end T3 through the other end T4, that is, the heating means may be configured such that calcining is performed in the entire second cylindrical body 5b. Here, the space from the one end T3 through the supply port P3 in FIG. 3 is also made to reach a high temperature with the heating means M3, and the first calcined particles supplied to the second cylindrical body 5b are thus heated immediately even before reaching the position corresponding to the heating means M3.

In the second calcining step, from the viewpoint of making it easy to adjust the degree of reduction of the catalyst, it is preferable to control temperatures with the heating means M3 such that a temperature C on the supply port P3 side of the second cylindrical body reaches a target temperature t3 selected from 600° C. to 800° C. and/or a maximum reached temperature D of the second cylindrical body reaches a target temperature t4 selected from 500° C. to 800° C.

Temperature measurement means M4′ for measuring the temperature C is not particularly limited as long as the temperature measurement means M4′ is disposed such that the distance to the supply port P3 becomes shorter than the distance to the carry-out port P4 in the rotation axis direction of the second cylindrical body.

Typically, the temperature measurement means M4′ can be said to be temperature measurement means least distant from the supply port P3 among the temperature measurement means M4. Regarding “temperature measurement means least distant from the supply port P3”, the exact position thereof is not limited as long as the temperature measurement means is intended to directly measure the temperature at “temperature measurement point least distant from the supply port P3.”

More specific description will be given using the example of FIG. 3. For the first calcined particles supplied the second cylindrical body 5b, it is preferable to control the temperature such that the temperature C that is measured with the temperature measurement means M4′ matches the target temperature t3, and here, the target temperature t3 is preferably selected from 600° C. to 800° C., more preferably selected from 300° C. to 700° C., and still more preferably selected from 400° C. to 650° C., and far still more preferably selected from 500° C. to 600° C. In addition, for the first calcined particles that moves in the arrow β direction, it is preferable to control the temperature such that the maximum reached temperature D that is measured with the temperature measurement means M4 matches the target temperature t4, and here, the target temperature t4 is preferably selected from 500° C. to 800° C. and more preferably selected from 600° C. to 700° C.

The heating pattern from the target temperature t3 to the target temperature t4 is not particularly limited, and the temperature may be linearly increased or the temperature may be increased in an arc shape that is convex upward or downward. At the time of increasing the temperature from the target temperature t3 to the target temperature t4, there may be a variation in which the temperature temporarily decreases, but the target temperature t4 is preferably held for 30 minutes or longer and more preferably held for one to 10 hours.

In the second supplying step, the first calcined particles may be supplied to the supply port P1 by gas transportation, and the gas transportation at that time can be performed by the same method for the gas transportation of the dry particles in the first supplying step. Here, the temperature of a gas that is used for the gas transportation is preferably controlled such that the variation range of the temperature C becomes 10° C. or less from the viewpoint of making it easy to adjust the degree of reduction of the catalyst.

In the present embodiment, from the viewpoint of holding the oxygen concentration in the second cylindrical body to be low and the viewpoint of adjustment of the redox degree, a third gas that does not get involved in the gas transportation can be directly supplied to the second cylindrical body. As the third gas, an inert gas is preferably used from the viewpoint of making it easy to adjust the degree of reduction of the catalyst. Such an inert gas is not particularly limited, and for example, a noble gas such as nitrogen or argon can be used. The third gas may be the same as or different from the gas that is used for the gas transportation. The amount of the third gas supplied is not particularly limited, but is preferably 5 NL/min or more and 100 NL/min or less, more preferably 10 NL/min or more and 90 NL/min or less, and still more preferably 20 NL/min or more and 80 NL/min or less per 1 kg/hr of the supply rate of the first calcined particle to the supply port P3 from the viewpoint of making it easy to adjust the degree of reduction of the catalyst.

In the present embodiment, from the viewpoint of making it easy to adjust the degree of reduction of the catalyst, it is preferable that the first cylindrical body and the second cylindrical body are cylindrical, the first cylindrical body further has a plurality of shuttering boards B1 that are disposed along the central axis direction on the inner wall of the cylindrical body, and the second cylindrical body further has a plurality of shuttering boards B2 that are disposed along the central axis direction on the inner wall of the cylindrical body.

In addition, the first cylindrical body and the second cylindrical body are preferably rotary kilns (cylindrical rotary furnaces) capable of preferably performing continuous calcining from the viewpoint of the productivity.

In the present embodiment, the first cylindrical body or the second cylindrical body may be horizontally supported or may be installed such that the longitudinal direction forms a predetermined angle with respect to the horizontal direction in order to make the one end T1 or T3 higher than the other end T2 or T4 to efficiently circulate the dry particles or the first calcined particles from the one end T1 or T3 to the other end T2 or T4. The angle of the first cylindrical body or the second cylindrical body being supported is preferably 0 to 70 degrees and more preferably 0.1 to 20 degrees.

In the present embodiment, the first cylindrical body or the second cylindrical body is preferably rotated around the longitudinal direction as an axis to prevent the cracking, breaking or the like of the first calcined particles and to homogeneously calcine the particles. The rotation speed of the first cylindrical body or the second cylindrical body is preferably 0.1 to 30 rpm, more preferably 0.3 to 20 rpm, and still more preferably 0.5 to 10 rpm.

In the present embodiment, it is possible to apply vibrations or impacts at constant intervals to the first cylindrical body or the second cylindrical body from the viewpoint of suppressing a change in heat transfer or unevenness during calcining due to the fixation of the catalyst, the first calcined particles or the like to the inner wall of the first cylindrical body or the second cylindrical body. More specifically, it is possible to employ the conditions and the like described in JP 5527994 B1.

The temperatures A to D and the individual variation ranges thereof in the present embodiment can be measured based on methods described in the examples.

In the present embodiment, the heating means M1 and/or the heating means M3 is preferably an external heat type from the viewpoint of making it easy to adjust the calcining temperature to follow a preferable heating pattern.

In the present embodiment, well-known measurement means can be employed as the temperature measurement means M1 and the temperature measurement means M4, and examples thereof include thermocouples and the like.

From the viewpoint of the catalyst performance, stable production, or the like, the oxygen concentrations in a space from the one end T1 to the other end T2 in the first cylindrical body and/or a space from the one end T3 to the other end T4 in the second cylindrical body are preferably set to 1000 ppm or lower. The oxygen concentrations are more preferably 500 ppm or lower and particularly preferably 200 ppm or lower. Therefore, the production is performed under an inert gas atmosphere substantially containing no oxygen such as a nitrogen gas, an argon gas, or a helium gas and preferably performed while an inert gas is circulated.

From the viewpoint of stable production or the like, the inner diameters and lengths of the first cylindrical body and/or the second cylindrical body are each preferably 100 mm to 3000 mm and 800 to 30000 mm. The inner diameter and length of the first cylindrical body and the inner diameter and length of the second cylindrical body may be the same as or different from each other.

In the present embodiment, the second calcined particles obtained through the second calcining step can be stored in a storage container such as a hopper, and there is a tendency that the second calcined particles are sufficiently mixed in a process of trapping the second calcined particles in the storage container.

### (Preparation Step)

In the present embodiment, it is possible to perform a preparation step of preparing the precursor before the drying step is performed, and it is preferable to add ammonia water to a liquid mixture of a metal compound in the preparation step from the viewpoint of further enhancing the catalyst performance. In the case of adding ammonia water to the precursor slurry, there is a tendency that the metal dissolution state in the precursor slurry is properly kept and, consequently, the degree of reduction of the metal is properly kept. The timing of adding to the precursor slurry can be adjusted as appropriate.

As the amount of ammonia to be added, ammonia is added such that the molar ratio of NH₃/Nb preferably reaches 0.1 or more and 5 or less, more preferably 0.2 or more and 4.5 or less, and still more preferably 0.3 or more and 3 or less. In a case where the molar ratio is 5 or less, there is a tendency that the degree of reduction of the metal is properly kept, consequently, the increase in the viscosity of an aqueous mixture, difficulty in feeding the aqueous mixture in the drying step, and distortion of the shape of the catalyst particle are prevented.

### (Projection Removal Step)

In a projection removal step that is arbitrarily performed in the present embodiment, projections present on the particle surfaces of the second calcined particles are removed. A majority of the projections are protruding oxide crystals or impurities thereof. Particularly, in the case of a calcined product containing a plurality of metals, there are cases where an oxide having a different composition from crystals that form the majority of the calcined product is formed in a shape in which the oxide exudes from the main body portion of the calcined product. Such projections tend to act as a cause of degrading the fluidity. Therefore, there is a tendency that the removal thereof from the surfaces of the second calcined particles make the performance of the catalyst improve. In the case of removing the projections on a gram scale, it is possible to use a device to be described below. That is, it is possible to use a vertical tube including a perforated plate having one or more holes in the bottom portion and a paper filter provided in the upper portion. When the second calcined particles are injected into this vertical tube, and an air is circulated from the lower portion, an air current flows from each hole to promote the contact between the second calcined particles, and the projections are removed.

### <<Method for Producing Acrylonitrile>>

A method for producing acrylonitrile of the present embodiment has a reaction step of causing a reaction (gas phase ammoxidation reaction) of propane, molecular oxygen, and ammonia in the presence of the catalyst of the present embodiment to produce acrylonitrile. As a reaction method, a well-known method such as a fixed-bed method, a fluidized-bed method, or a moving-bed method can be employed. The reaction conditions for the gas phase ammoxidation reaction are not particularly limited, but the following conditions can be exemplified. The mol ratio of oxygen that is supplied for the reaction to propane is preferably 0.1 or more and 6.0 or less and more preferably 0.5 or more and 5.0 or less. The mol ratio of ammonia to propane is preferably 0.3 or more and 1.5 or less and more preferably 0.5 or more and 1.4 or less. The reaction temperature is preferably 300° C. or higher and 500° C. or lower and more preferably 350° C. or higher and 500° C. or lower.

### EXAMPLES

Hereinafter, the present embodiment will be described in more detail by showing examples, but the present embodiment is not limited by the examples described below.

### Example 1

### [Preparation of Niobium Starting Material Solution]

A niobium starting material solution was prepared by the following method. 77.8 kg of water was added into a mixing tank, and the water was then heated to 45° C. Next, 72.2 kg of oxalic acid dihydrate [H₂C₂O₄·2H₂O] was injected thereinto under stirring, subsequently, 20.0 kg of niobic acid that was contained 76.0 mass % as Nb₂O₅ was injected thereinto, and both the oxalic acid dihydrate and the niobic acid were mixed together in the water. An aqueous mixture obtained by heating and stirring this solution at 70° C. for eight hours was placed still and cooled with ice, and a solid was then filtered by suction filtration, thereby obtaining a homogeneous niobium starting material solution. The oxalic acid/niobium molar ratio of this niobium starting material solution was found out to be 2.11 by the following analysis. The obtained niobium starting material solution was used as a niobium starting material solution in the production of a catalyst of the following examples and comparative examples. The oxalic acid/niobium molar ratio of the niobium starting material solution was calculated as described below. As a result of calculating the Nb concentration of the niobium starting material solution from the weight of solid Nb₂O₅ obtained by precisely weighing 10 g of the niobium starting material solution in a crucible, drying the solution at 120° C. for two hours and then thermally treating the residue at 600° C. for two hours, the Nb concentration was 0.889 mol/kg. In addition, 3 g of the niobium starting material solution was precisely weighed in a 300 mL glass beaker, 20 mL of approximately 80° C. hot water was added thereto, and subsequently, 10 mL of 1:1 sulfuric acid was added thereto. A liquid mixture obtained as described above was titrated using 1/4 regulation KMnO₄ under stirring while being held at a liquid temperature of 70° C. in a water bath. A point at which the faint pale pink color attributed to KMnO₄ continued for 30 seconds or longer was regarded as the end point. The oxalic acid concentration was calculated from the titration amount according to the following formula, and the oxalic acid concentration was consequently found out to be 1.88 mol/kg.

2KMNO₄+3H₂SO₄+5H₂C₂O₄→K₂SO₄+2MnSO₄+10CO₂+8H₂O

The turbidity was measured using 2100AN Turbidimeter manufactured by HACH Company after the liquid mixture was placed still for one day from the preparation. 30 mL of the niobium starting material solution was put into a measurement cell, and the turbidity was measured based on US EPA method 180.1 and consequently found out to be 52 NTU.

### [Preparation of Catalyst Precursor]

A catalyst (silica-supported catalyst) represented by a composition formula Mo₁V_{0.19}Sb_{0.26}Nb_{0.14}On/46 mass %-SiO₂ was prepared as described below.

### [Preparation of Starting Material-Compounded Solution]

17.3 kg of ammonium heptamolybdate [(NH₄)₆Mo₇O₂₄·4H₂O], 2.2 kg of ammonium metavanadate [NH₄VO₃], and 3.7 kg of antimony trioxide [Sb₂O₃] were added to 104 kg of water and heated at 90° C. for three hours under stirring, thereby obtaining an aqueous mixture. The aqueous mixture was cooled to 70° C., and 23.7 kg of a silica sol that was contained 34.1 mass % as SiO₂ was then added thereto. Next, 7.4 kg of a hydrogen peroxide solution containing 35.3 mass % of H₂O₂ was added thereto, the aqueous mixture was cooled to 50° C., and 15.4 kg of the niobium starting material solution, furthermore, a solution obtained by dispersing 9.9 kg of fumed silica in 89.1 kg of water, and next, 2.1 kg of 27.3% ammonia water were then added thereto, thereby obtaining a starting material-compounded solution. A starting material mixture was heated to 65° C. and reacted for two hours under stirring, thereby obtaining a slurry-like aqueous mixture.

### [Preparation of Catalyst Precursor (Dry Particles)]

The obtained slurry-like aqueous mixture was supplied to and dried in a centrifugal spray dryer, thereby obtaining micro spherical dry particles. The inlet temperature of the dryer was 210° C., and the outlet temperature was 120° C. The step of preparing the dry particles was repeated to continuously perform a calcining step, which will be described below.

### [Transportation of Catalyst to Calcining Machine]

Thereafter, a manufacturing device having the same configuration as in the device shown in FIG. 1 was used. The obtained dry particles were added as appropriate to a storage container 2 for supplying the dry particles to a calcining machine 5 where the calcining step (continuous calcining) was to be performed. At the time of transporting the dry particles from the storage container 2 to the calcining machine 5, the temperature of a nitrogen gas, which was a transportation medium, was adjusted. First, 60° C. water was circulated as a heat medium into a heat exchanger 1 from a pipe 10. The nitrogen gas was guided to the heat exchanger 1 from a pipe 11, adjusted to a desired temperature, then, joined with the dry particles that were carried out from the storage container 2 through a pipe 13 in a pipe 12, and guided to an injected powder collection machine 4. The temperature of the dry particles was measured over time at a temperature measurement point 3. Here, the temperature of the water that was circulated into the heat exchanger 1 was adjusted such that the temperature that was measured at the temperature measurement point 3 reached 50° C. and a variation in the injection temperature was suppressed based on the change of the measurement temperature over time. The temperature and flow rate of the nitrogen gas, which was the transportation medium, were set to 50° C. and 7 NL/min, respectively. Some of the nitrogen gas, which was the transportation medium, was supplied to the heat exchanger 1 (first cylindrical body) through the injected powder collection machine 4, and the remainder of the nitrogen gas was separated from the dry particles in the injected powder collection machine 4 and discharged out of the system through a pipe 15.

### [Calcining Step]

### (First Stage of Calcining)

As a calcining machine, a SUS cylindrical calcining pipe that was 150 mm in inner diameter, 1150 mm in length, and 7 mm in thickness (first cylindrical body having a heating furnace disposed in a cylinder) was used. This first cylindrical body had the same configuration as in FIG. 2. That is, the first cylindrical body had a supply port P1 that guided the dry particles into a cylindrical body at one end T1 of the cylindrical body in a rotation axis direction, a carry-out port P2 that carried out the calcined particles to the outside of the cylindrical body at the other end T2 in the rotation axis direction, heating means M1 that heated the inside of the cylindrical body along the rotation axis direction, and a plurality of temperature measurement means M2 that measure the temperatures of substantially the central portion along the rotation axis direction in the cylindrical body.

Here, in order to evaluate a temperature change on the supply port P1 side in the first cylindrical body, a temperature that was measured with, among the temperature measurement means M2, temperature measurement means M2′ that was disposed at a position least distant from the supply port P1 was defined as a temperature A and used to evaluate the variation range thereof. In addition, a temperature that was measured with, among the temperature measurement means M2, temperature measurement means M2″ that was disposed at a position least distant from the carry-out port P2 was defined as a temperature B and used to control temperatures such that the temperatures A and B reached predetermined target temperatures t1 and t2. Each temperature is shown in Table 1. As Temperature A in the table, values determined as the average values of actual measurement values obtained by recording temperatures every minute for 120 hours from when 24 hours elapsed to when 144 hours elapsed from a point in time where the supply of the powder to the first cylindrical body began (during this period, the dry particles were continuously supplied). In addition, as Temperature B in the table as well, values determined as the average values of actual measurement values obtained by recording temperatures every minute for 120 hours from when 24 hours elapsed to when 144 hours elapsed from a point in time where the supply of the powder to the first cylindrical body began (during this period, the dry particles were continuously supplied). Regarding Temperature A and Temperature B in the tables, what has been described above is also true in the following examples and comparative examples.

In the inner wall of the first cylindrical body, seven shuttering boards (not shown) were installed to equally divide the length of the heating furnace portion into eight sections. All of the shutting boards were 30 mm in height and had a rising slope in the transportation direction of the dry particles and an annular shape. Together with such a configuration, the dry particles were circulated into the first cylindrical body in which the target temperature t1 of the temperature A that was measured by the temperature measurement means M2′ disposed on the supply port P1 side was set to 150° C. through a pipe that extended from the storage container, and a nitrogen gas (second gas) was circulated into the first cylindrical body from a pipe, not shown, at 10 NL/min (a supply rate of the dry particles to the supply port P1 of 1 kg/hr is equal to 33.3 NL/min). Here, while the first cylindrical body was rotated at 5 rpm, the heating means M1 was controlled to obtain a temperature profile in which the dry particles were calcined at a target temperature t2=380° C. for three hours, and the first stage of calcining was performed, thereby obtaining first calcined particles.

### (Second Stage of Calcining)

Next, the first calcined particles were supplied to a calcining machine that was a separate body from the first cylindrical body (second cylindrical body) disposed on the wake side of the first cylindrical body through a pipe that extended from the first cylindrical body. As this second cylindrical body, a SUS cylindrical calcining pipe that was 150 mm in inner diameter, 1150 mm in length, and 7 mm in thickness (the inside of the cylinder served as a heating furnace) was used. This second cylindrical body had the same configuration as in FIG. 3. That is, the second cylindrical body had a supply port P3 that guided the first calcined particles into a cylindrical body at one end T3 of the cylindrical body in a rotation axis direction, a carry-out port P4 that carried out the first calcined particles at the other end T4 in the rotation axis direction, heating means M3 that heated the inside of the cylindrical body along the rotation axis direction, and a plurality of temperature measurement means M4 that measure the temperatures of substantially the central portion of the cylindrical body along the rotation axis direction.

Here, in order to evaluate a temperature change on the supply port P3 side in the second cylindrical body, a temperature that was measured with, among the temperature measurement means M4, temperature measurement means M4′ that was disposed at a position least distant from the supply port P3 was defined as a temperature C and used to evaluate the variation range thereof. In addition, when the highest value of the temperatures that were shown by the temperature measurement means M4 was defined as a temperature D, temperatures were controlled such that the temperatures t3 and t4. Each temperature is shown in Table 1. As Temperature C in the table, values determined as the average values of actual measurement values obtained by recording temperatures every minute for 120 hours from when 24 hours elapsed to when 144 hours elapsed from a point in time where the supply of the powder to the second cylindrical body began (during this period, the dry particles were continuously supplied). In addition, as Temperature D in the table as well, values determined as the average values of actual measurement values obtained by recording temperatures every minute for 120 hours from when 24 hours elapsed to when 144 hours elapsed from a point in time where the supply of the powder to the second cylindrical body began (during this period, the dry particles were continuously supplied). Regarding Temperature C and Temperature D in the tables, what has been described above is also true in the following examples and comparative examples.

In the inner wall of the second cylindrical body, seven shuttering boards (not shown) were installed to equally divide the length of the heating furnace portion into eight sections. All of the shutting boards were 30 mm in height and had a rising slope in the transportation direction of the dry particles and an annular shape. That is, the shuttering boards were formed to be covered with the inner wall of the cylindrical body.

Together with such a configuration, the first calcined particles were circulated into the second cylindrical body in which the target temperature t3 of the temperature C on the supply port P3 side was set to 580° C. at a rate of 250 g/hr. At that time, the second cylindrical body was rotated at 5 rpm, and a nitrogen gas (third gas) was circulated into the second cylindrical body from a pipe, not shown, at 8 NL/min (a supply rate of the first calcined particles to the supply port P3 of 1 kg/hr is equal to 32 NL/min) while a powder introduction side portion (a portion not covered with the heating means M3) of the second cylindrical body was struck every five seconds with a hammering device having an SUS hammer with a mass of 2 kg installed at the tip of a striking portion from a height of 30 mm above the second cylindrical body in a direction perpendicular to the rotation axis. Here, the heating means M3 was controlled to obtain a temperature profile in which the first calcined particles were calcined at a target temperature t4=670° C. for two hours, and final calcining was performed, thereby obtaining a catalyst.

The temperature variation range of the temperature A, which was a difference between the maximum temperature (the maximum value of the temperature A) and the minimum temperature (the minimum value of the temperature A) of the dry particles that were supplied to the first cylindrical body, from the beginning of the calcining to the end of the calcining, was 2.0° C. Such a temperature variation range was specified with, among the temperature measurement means M2, the temperature measuring means M2′ disposed on the supply port P1 side based on the values of the measured temperatures. That is, the difference between the maximum temperature and the minimum temperature measured with the temperature measurement means M2′ during the period was specified as the temperature variation range. The temperature variation range of the temperature C was also measured in the same manner as described above and was found out to be 4.2° C.

In the production system of Example 1, it was confirmed that the temperature A and the temperature C well matched the temperature at a position A shown in FIG. 8, and in the following examples and comparative examples as well, the temperature A and the temperature C were determined to be regarded as the temperature of the dry particles or the first calcined particles that were present at the position A shown in FIG. 8. Here, FIG. 8 can be regarded as a schematic cross-sectional view of the first cylindrical body when cross-sectionally viewed from the most upstream portion of the heating means M1 or a schematic cross-sectional view of the second cylindrical body when cross-sectionally viewed from the most upstream portion of the heating means M3, and in FIG. 8, the dry particles or the first calcined particles are present in the lower portion (hatched portion: a presence region of the dry particles or the first calcined particles), and the upper portion is a gas phase. The position A can be specified as, in the presence region of the dry particles or the first calcined particles, a position corresponding to the middle point between a point where the first cylindrical body and the dry particles come into contact with each other or a point where the second cylindrical body and the first calcined particles come into contact with each other and a point on the surface of the presence region of the dry particles or the first calcined particles on a straight line where the depth in the vertical direction is maximized.

### [Removal of Projection]

Fifty grams of the catalyst was added into a vertical tube (41.6 mm in internal diameter and 70 cm in length) including a perforated disc having three holes with a diameter of 1/64 inches in the bottom portion and a paper filter provided in the upper portion under an air flow. In a direction in which an air current flowed at this time, the length of the air current was 52 mm, and the average linear velocity was 310 m/s. As a result of confirming the catalyst obtained after 24 hours with SEM, it was not possible to confirm the presence of a projection on the surface of the catalyst.

As a result of observing a cross section with SEM based on a method to be described below and performing image processing on 20 randomly extracted particles (five fields of view), σ/A was 0.125, and B/C was 11.5. As a result of performing a catalyst performance test based on a method to be described below, the ammonia burn rate was 16%, and the AN yield was 56.5%.

### Example 2

### [Preparation of Catalyst Precursor]

A catalyst (silica-supported catalyst) represented by a composition formula Mo₁V_{0.17}Sb_{0.24}Nb_{0.11}On/47 mass %-SiO₂ was manufactured as described below.

### [Preparation of Starting Material-Compounded Solution]

17.6 kg of ammonium heptamolybdate [(NH₄)₆Mo₇O₂₄·4H₂O], 2.0 kg of ammonium metavanadate [NH₄VO₃], and 3.5 kg of antimony trioxide [Sb₂O₃] were added to 94.9 kg of water and heated at 90° C. for three hours under stirring, thereby obtaining an aqueous mixture. The aqueous mixture was cooled to 70° C., and 26.0 kg of a silica sol that was contained 34.1 mass % as SiO₂ was then added thereto. Next, 6.9 kg of a hydrogen peroxide solution containing 35.3 mass % of H₂O₂ was added thereto, the aqueous mixture was cooled to 50° C., and 12.3 kg of the niobium starting material solution, furthermore, a solution obtained by dispersing 9.6 kg of fumed silica in 86.6 kg of water, and next, 1.7 kg of 27.3% ammonia water were then added thereto, thereby obtaining a starting material-compounded solution. A starting material mixture was heated to 65° C. and reacted for two hours under stirring, thereby obtaining a slurry-like aqueous mixture.

Dry particles were prepared by the same method as in Example 1 using the above-described slurry-like aqueous mixture.

### [Transportation of Catalyst to Calcining Machine]

A catalyst was transported by the same method as in Example 1.

Except that the target temperatures t1 in Example 1 was changed to 180° C., calcining and the removal of projections were performed by the same methods as in Example 1 using the above-described dry particles, thereby obtaining a catalyst. At this time, the temperature variation ranges of the temperature A and the temperature C that were specified by the above-described method were 3.5° C. and 3.8° C., respectively.

As a result of observing a cross section with SEM based on the method to be described below and performing image processing on 20 randomly extracted particles (five fields of view), σ/A was 0.122, and B/C was 11.3. As a result of performing a catalyst performance test based on a method to be described below, the ammonia burn rate was 16%, and the AN yield was 56.6%.

### Example 3

### [Preparation of Catalyst Precursor]

A catalyst (silica-supported catalyst) represented by a composition formula Mo₁V_{0.23}Sb_{0.23}Nb_{0.08}W_{0.03}On/49.0 mass %-SiO₂ was manufactured as described below.

### [Preparation of Starting Material-Compounded Solution]

16.7 kg of ammonium heptamolybdate [(NH₄)₆Mo₇O₂₄·4H₂O], 2.5 kg of ammonium metavanadate [NH₄VO₃], and 3.2 kg of antimony trioxide [Sb₂O₃] were added to 111 kg of water and heated at 90° C. for three hours under stirring, thereby obtaining an aqueous mixture. The aqueous mixture was cooled to 70° C., and 34.5 kg of a silica sol that was contained 34.1 mass % as SiO₂ was then added thereto. Next, 6.3 kg of a hydrogen peroxide solution containing 35.3 mass % of H₂O₂ was added thereto, the aqueous mixture was cooled to 50° C., and 8.5 kg of the niobium starting material solution, 0.21 kg (purity: 49.9%) of an ammonium metatungstate aqueous solution, furthermore, a solution obtained by dispersing 7.7 kg of fumed silica in 69.4 kg of water, and next, 1.7 kg of 27.3% ammonia water were then added thereto, thereby obtaining a starting material-compounded solution. A starting material mixture was heated to 65° C. and reacted for two hours under stirring, thereby obtaining a slurry-like aqueous mixture.

Dry particles were prepared by the same method as in Example 1 using the above-described slurry-like aqueous mixture.

### [Transportation of Catalyst to Calcining Machine]

A catalyst was transported to a calcining machine by the same method as in Example 1.

Except that the target temperatures t2 and t4 in Example 1 were changed to 360° C. and 650° C., respectively, calcining and the removal of projections were performed by the same methods as in Example 1 using the above-described dry particles, thereby obtaining a catalyst. At this time, the temperature variation ranges of the temperature A and the temperature C that were specified by the above-described method were 2.3° C. and 5.0° C., respectively.

As a result of observing a cross section with SEM based on the method to be described below and performing image processing on 20 randomly extracted particles (five fields of view), σ/A was 0.190, and B/C was 12.3. As a result of performing a catalyst performance test based on a method to be described below, the ammonia burn rate was 18%, and the AN yield was 54.9%.

### Example 4

Preparation of a starting material-compounded solution and preparation of dry particles were performed such that the metal composition became the same as in Example 1.

### [Transportation of Catalyst to Calcining Machine]

A catalyst was transported to a calcining machine by the same method as in Example 1 except that the nitrogen gas, which was the transportation medium, was set to 1000 NL/min.

### [Calcining Step]

### (First Stage of Calcining)

As a calcining machine, a SUS cylindrical calcining pipe having a larger scale than the calcining machine of Example 1, specifically, a SUS cylindrical calcining pipe that was 500 mm in inner diameter, 4500 mm in length, and 20 mm in thickness (first cylindrical body in which the inside of the cylinder served as a heating furnace) was used. This first cylindrical body had the same configuration as in FIG. 2. That is, the first cylindrical body had a supply port P1 that guided the dry particles into a cylindrical body at one end T1 of the cylindrical body in a rotation axis direction, a carry-out port P2 that carried out the calcined particles to the outside of the cylindrical body at the other end T2 in the rotation axis direction, heating means M1 that heated the inside of the cylindrical body along the rotation axis direction, and a plurality of temperature measurement means M2 that measure the temperatures of substantially the central portion along the rotation axis direction in the cylindrical body.

Here, in order to evaluate a temperature change on the supply port P1 side in the first cylindrical body, a temperature that was measured with, among the temperature measurement means M2, temperature measurement means M2′ that was disposed at a position least distant from the supply port P1 was defined as a temperature A and used to evaluate the variation range thereof. In addition, a temperature that was measured with, among the temperature measurement means M2, temperature measurement means M2′ that was disposed at a position least distant from the carry-out port P2 was defined as a temperature B, and temperatures were controlled such that the temperatures A and B reached predetermined target temperatures t1 and t2. Each temperature is shown in Table 1.

In the inner wall of the first cylindrical body, seven shuttering boards (not shown) were installed to equally divide the length of the heating furnace portion into eight sections. All of the shutting boards were 150 mm in height and had a rising slope in the transportation direction of the dry particles and an annular shape. The dry particles were circulated into such a first cylindrical body at a rate of 25 kg/hr through a pipe that extended from the storage container, and a nitrogen gas (second gas) was circulated into the first cylindrical body from a pipe, not shown, at 1000 NL/min (a supply rate of the dry particles to the supply port P1 of 1 kg/hr is equal to 40 NL/min). Here, while the first cylindrical body was rotated at 5 rpm, the heating means M1 was controlled to obtain a temperature profile in which the dry particles were held at a target temperature t2=380° C. for three hours, and the first stage of calcining was performed, thereby obtaining first calcined particles.

At this time, the temperature variation range of the temperature A that was specified by the above-described method was 5.4° C.

### (Second Stage of Calcining)

Next, the first calcined particles were supplied to a calcining machine that was a separate body from the first cylindrical body (second cylindrical body) disposed on the wake side of the first cylindrical body through a pipe that extended from the first cylindrical body. As this second cylindrical body, a SUS cylindrical calcining pipe that was 500 mm in inner diameter, 4500 mm in length, and 20 mm in thickness (the inside of the cylinder served as a heating furnace) was used. This second cylindrical body had the same configuration as in FIG. 3. That is, the second cylindrical body had a supply port P3 that guided the first calcined particles into a cylindrical body at one end T3 of the cylindrical body in a rotation axis direction, a carry-out port P4 that carried out the first calcined particles at the other end T4 in the rotation axis direction, heating means M3 that heated the inside of the cylindrical body along the rotation axis direction, and a plurality of temperature measurement means M4 that measure the temperatures of substantially the central portion of the cylindrical body along the rotation axis direction.

Here, in order to evaluate a temperature change on the supply port P3 side in the second cylindrical body, a temperature that was measured with, among the temperature measurement means M4, temperature measurement means M4′ that was disposed at a position least distant from the supply port P3 was defined as a temperature C and used to evaluate the variation range thereof. In addition, when the highest value of the temperatures that were shown by the temperature measurement means M4 was defined as a temperature D, temperatures were controlled such that the temperatures t3 and t4. Each temperature is shown in Table 1.

In the inner wall of the second cylindrical body, seven shuttering boards (not shown) were installed to equally divide the length of the heating furnace portion into eight sections. All of the shutting boards were 150 mm in height and had a rising slope in the transportation direction of the dry particles and an annular shape. That is, the shuttering boards were formed to be covered with the inner wall of the cylindrical body.

The first calcined particles were circulated into such a second cylindrical body at a rate of 20 kg/hr. At that time, the second cylindrical body was rotated at 5 rpm, and a nitrogen gas (third gas) was circulated into the second cylindrical body from a pipe, not shown, at 800 NL/min (a supply rate of the first calcined particles to the supply port P3 of 1 kg/hr is equal to 40 NL/min) while a powder introduction side portion (a portion not covered with the heating means M3) of the second cylindrical body was struck every five seconds with a hammering device having an SUS hammer with a mass of 14 kg installed at the tip of a striking portion from a height of 250 mm above the second cylindrical body in a direction perpendicular to the rotation axis. Here, the heating means M3 was controlled to obtain a temperature profile in which the first calcined particles were calcined at a target temperature t4=670° C. for two hours, and final calcining was performed, thereby obtaining a catalyst.

At this time, the temperature variation range of the temperature C that was specified by the above-described method was 6.6° C.

As a result of observing a cross section with SEM based on a method to be described below and performing image processing on 20 randomly extracted particles (five fields of view), σ/A was 0.235, and B/C was 12.0. As a result of performing a catalyst performance test based on a method to be described below, the ammonia burn rate was 20%, and the AN yield was 56.0%.

### Example 5

Preparation of a starting material-compounded solution and preparation of dry particles were performed such that the metal composition became the same as in Example 2.

### [Transportation of Catalyst to Calcining Machine]

A catalyst was transported to the same calcining machine as in Example 4 by the same method as in Example 4.

Except that the target temperature t1 in Example 1 was changed to 180° C., calcining and the removal of projections were performed by the same methods as in Example 1 using the above-described dry particles, thereby obtaining a catalyst. At this time, the temperature variation ranges of the temperature A and the temperature C that were specified by the above-described method were 8.6° C. and 7.2° C., respectively.

As a result of observing a cross section with SEM based on the method to be described below and performing image processing on 20 randomly extracted particles (five fields of view), σ/A was 0.224, and B/C was 13.5. As a result of performing a catalyst performance test based on a method to be described below, the ammonia burn rate was 22%, and the AN yield was 55.4%.

### Example 6

Preparation of a starting material-compounded solution and preparation of dry particles were performed such that the metal composition became the same as in Example 3.

### [Transportation of Catalyst to Calcining Machine]

A catalyst was transported to the same calcining machine as in Example 4 by the same method as in Example 4.

Except that the target temperatures t2 and t4 in Example 1 were changed to 360° C. and 650° C., respectively, calcining and the removal of projections were performed by the same methods as in Example 1 using the above-described dry particles, thereby obtaining a catalyst. At this time, the temperature variation ranges of the temperature A and the temperature C that were specified by the above-described method were 5.5° C. and 8.0° C., respectively.

As a result of observing a cross section with SEM based on the method to be described below and performing image processing on 20 randomly extracted particles (five fields of view), σ/A was 0.232, and B/C was 13.3. As a result of performing a catalyst performance test based on a method to be described below, the ammonia burn rate was 22%, and the AN yield was 54.0%.

### Example 7

### [Preparation of Catalyst Precursor]

Except that the ammonia water was not added, preparation of a starting material-compounded solution and preparation of dry particles were performed such that the metal composition became the same as in Example 1. That is, the starting material-compounded solution was prepared as described below.

### [Preparation of Starting Material-Compounded Solution]

17.3 kg of ammonium heptamolybdate [(NH₄)₆Mo₇O₂₄·4H₂O], 2.2 kg of ammonium metavanadate [NH₄VO₃], and 3.7 kg of antimony trioxide [Sb₂O₃] were added to 104 kg of water and heated at 90° C. for three hours under stirring, thereby obtaining an aqueous mixture. The aqueous mixture was cooled to 70° C., and 23.7 kg of a silica sol that was contained 34.1 mass % as SiO₂ was then added thereto. Next, 7.4 kg of a hydrogen peroxide solution containing 35.3 mass % of H₂O₂ was added thereto, the aqueous mixture was cooled to 50° C., and 15.4 kg of the niobium starting material solution and, furthermore, a solution obtained by dispersing 9.9 kg of fumed silica in 89.1 kg of water were then added thereto, thereby obtaining a starting material-compounded solution. A starting material mixture was heated to 65° C. and reacted for two hours under stirring, thereby obtaining a slurry-like aqueous mixture.

Dry particles were prepared by the same method as in Example 1 using the above-described slurry-like aqueous mixture.

### [Transportation of Catalyst to Calcining Machine]

A catalyst was transported to the same calcining machine as in Example 1 by the same method as in Example 1.

Calcining and the removal of projections were performed by the same methods as in Example 1 using the above-described dry particles, thereby obtaining a catalyst. At this time, the temperature variation ranges of the temperature A and the temperature C that were specified by the above-described method were 3.1° C. and 4.5° C., respectively.

As a result of observing a cross section with SEM based on the method to be described below and performing image processing on 20 randomly extracted particles (five fields of view), σ/A was 0.227, and B/C was 12.7. As a result of performing a catalyst performance test based on a method to be described below, the ammonia burn rate was 20%, and the AN yield was 55.8%.

### Comparative Example 1

Preparation of a starting material-compounded solution and preparation of dry particles were performed such that the metal composition became the same as in Example 1.

### [Transportation of Catalyst to Calcining Machine]

The obtained dry particles were added as appropriate to the storage container for supplying the dry particles to the calcining machine where the calcining step (continuous calcining) was to be performed. The dry particles were transported from the storage container to the calcining machine without adjusting the temperature of the dry particles that were added into the calcining machine. A nitrogen gas was circulated at 1000 L/min and used for the transportation of the dry particles.

Calcining and the removal of projections were performed by the same methods as in Example 4 using the above-described dry particles, thereby obtaining a catalyst. At this time, the temperature variation ranges of the temperature A and the temperature C that were specified by the above-described method were 15.4° C. and 19.2° C., respectively.

As a result of observing a cross section with SEM based on the method to be described below and performing image processing on 20 randomly extracted particles (five fields of view), σ/A was 0.335, and B/C was 11.9. As a result of performing a catalyst performance test based on a method to be described below, the ammonia burn rate was 25%, and the AN yield was 55.6%.

### Comparative Example 2

Preparation of a starting material-compounded solution and preparation of dry particles were performed such that the metal composition became the same as in Example 1.

### [Transportation of Catalyst to Calcining Machine]

The obtained dry particles were added as appropriate to the storage container for supplying the dry particles to the calcining machine where the calcining step (continuous calcining) was to be performed. The dry particles were transported from the storage container to the calcining machine without adjusting the temperature of the dry particles that were injected into the calcining machine. A nitrogen gas was circulated at 1000 L/min and used for the transportation of the dry particles.

Calcining and the removal of projections were performed by the same methods as in Example 4 using the above-described dry particles, thereby obtaining a catalyst. At this time, the temperature variation ranges of the temperature A and the temperature C that were specified by the above-described method were 16.0° C. and 20.5° C., respectively.

As a result of observing a cross section with SEM based on the method to be described below and performing image processing on 20 randomly extracted particles (five fields of view), σ/A was 0.422, and B/C was 10.9. As a result of performing a catalyst performance test based on a method to be described below, the ammonia burn rate was 27%, and the AN yield was 55.5%.

### [Catalyst Performance Test]

The catalyst performance test was performed by filling a fixed-bed reactor (diameter: 10 mm) with 2.0 g of the catalyst and introducing a gas mixture (6.4 vol % of propane, 7.7 vol % of ammonia, 17.9 vol % of oxygen, and 68.0 vol % of helium) at a predetermined temperature (440° C.) and a predetermined pressure (0.06 kg/G) while adjusting the flow rate such that the Pn conversion rate reached 89% to 90%. The flow rates were within a range of approximately 14.0 to 16.0 Ncc/min. in all examples. Gas reaction products after the beginning of a reaction and after approximately two hours were analyzed by gas chromatography.

The ammonia burn rate was defined as a numerical value obtained by dividing a value twice the amount (mol) of nitrogen detected per hour by the amount (mol) of ammonia added per hour.

### [Median Diameter]

The median diameter of the catalyst was obtained from a particle diameter at which the cumulative frequency from the small particle size side reached 50% in a particle size distribution measured according to JIS R 1629-1997 “Determination of particle size distributions for fine ceramic raw powders by laser diffraction method.” That is, the median diameter was measured from the catalyst particles (target) after the second stage of calcining using a laser diffraction particle size analyzer LS230 (trade name) manufactured by Beckman Coulter, Inc.

### [Preparation of Cross-Sectional SEM Sample]

An epoxy resin main agent (main components: bisphenol A and butyl glycidyl ether) and a curing agent (main component: triethylene tetramine) were mixed in a ratio of 10:1 and stirred for two minutes or longer. A spoonful of the catalyst held with a spatula was spread on the bottom of a ring-like plastic container, and an epoxy resin solution was further made to flow thereinto. The catalyst was dried at 25° C. for 12 hours or longer and solidified. A resin sample in which the catalyst had been implanted was removed from the container, and a surface where the catalyst was present was polished using 2000 or more-grit sandpaper. Furthermore, the surface was mirror-polished using an abrasive containing 0.3 μm alumina, thereby producing a sample for cross-sectional SEM observation.

### [SEM Observation]

The cross-sectional sample was observed with SEM (manufactured by Hitachi High-Tech Corporation, SU-70), and a backscattered electron image was acquired. The SEM acquisition conditions were an accelerating voltage of 15 kV, a magnification of 700 times, the resolution of 512 dpi, the size of 2560 pixels×1920 pixels, and the depth reached eight bits. Further, the contrast was adjusted such that the brightness value of the background other than the catalyst portions reached 0 to 40, the average value of the brightness values of portions of support in the catalyst reached approximately 70 to 140, and the brightness value of the central portion of a metal oxide region reached 255. Subsequently, the image was preserved in a TIFF format to prevent the deterioration of the image quality in an image processing step.

### [Image Analysis]

Image analysis was performed by mounting Open-CV library using Python. <1> Binarization process, <2> σ/A calculation, and <3> B/C calculation were executed as described below using the cross-sectional SEM image.

### <1> Binarization Process

### [Acquisition of Image for Catalyst Analysis]

(i) A grayscale process was performed on a cross-sectional image of the catalyst.
(ii) A median filter process in which the kernel size was set to 9 pixels×9 pixels was performed on the image after the (i).
(iii) Otsu's binarization on the image after the (ii) was performed.
(iv) Contour extraction was performed on the image after the (iii) based on the binarization result.
(v) On the image after the (iv), a process for whitening a region where the number of pixels in the contour was 250000 pixels or more and 750000 pixels or less was performed, a process for blackening a region outside the contour that was a region outside the region where the number of pixels in the contour was 250000 pixels or more and 750000 pixels or less was performed, and a binarization processed image BP₁ was acquired.
(vi) A masking process on the image after the (i) was performed based on the blackened pixel information of the binarization processed image BP₁ acquired in the (v), and an image for catalyst analysis in which outer regions of the contours of the catalyst particles each having an area of 1200 μm² or more were regarded as black regions and the insides of the contours were regarded as catalyst particle regions was acquired.

### [Process for Specifying White Region Based on Image for Catalyst Analysis]

(vii) A median filter process in which the kernel size was set to 5×5 was performed on the image for catalyst analysis obtained in the (vi).
(viii) A binarization process in which a brightness value at which the number of pixels became a local minimum value in a brightness value range of 150 or more and 255 or less was defined as a threshold value was performed on the image after the (vii), the insides of the catalyst particles were classified into the white regions and the black regions, and a binarization processed image BP₂ in which the white regions were specified was acquired.
   <2> σ/A calculation
(I) In the binarization processed image BP₂ acquired in the <1>, the area C₀ of one arbitrary catalyst particle region and the area W₀ of the white region in the catalyst particle region were calculated.
(II) Outermost edges E, that were vertically and horizontally adjacent to the one arbitrary catalyst particle region used in the (I) and were composed of each pixel unit were shaved, and the area C₁ of the remaining catalyst particle region and the area W₁ of the white region in the remaining catalyst particle region were calculated.
(III) a ratio F₀=(W₁−W₀)/(C₀−C₁) of the white region to the catalyst particle region in the outermost edges E₀ was calculated.
(IV) Outermost edges E₁ that were vertically and horizontally adjacent to the remaining catalyst particle region in the (II) and were composed of each pixel unit were shaved, and the area C₂ of the remaining catalyst particle region and the area W₂ of the white region in the remaining catalyst particle region were calculated.
(V) The ratio F₁=(W₁−W₂)/(C₁−C₂) of the white region to the catalyst particle region in the outermost edges E₁ was calculated.
(VI) The same processes as the (IV) and the (V) were repeated until outermost edges Eₙ that made it impossible to shave outermost edges any longer were shaved, and Cₙ, Wₙ, and Fₙ were calculated, where Fₙ is represented by Fₙ=(Wₙ−Wₙ₊₁)/(Cₙ−Cₙ₊₁).
(VII) When the local maximum value among F₁ to Fₙ was represented by F (0≤k≤n), the distance Dₖ from the surface of the catalyst particle to the outermost edge Eₖ indicating the local maximum value was defined as Dₖ=0.14*(k+1)−0.07, and Dₖ was calculated.
(VIII) The operations of the (I) to (VI) were performed on 20 arbitrary and different catalyst particle regions that were obtained from the binarization processed image BP₂, and 20 Dₖ's corresponding to the individual catalyst particle regions were obtained.
(IX) The average of the 20 Dₖ's obtained in the (VIII) was represented by A, the sample standard deviation of the 20 Dₖ's was represented by, and the coefficient of variation σ/A was calculated.

The coefficient of variation is an ordinary statistical index. Coefficients of variation of 0.20 or less were evaluated as small variations, coefficients of variation of 0.20 or more and 0.50 or less were evaluated as intermediate variations, and coefficients of variation of 0.50 or more and 1.00 or less were evaluated as large variations.

Hereinafter, the case of Example 2 will be used as an example, a SEM image of a catalyst cross section will be shown in FIG. 4, and the above-described series of analysis method will be described.

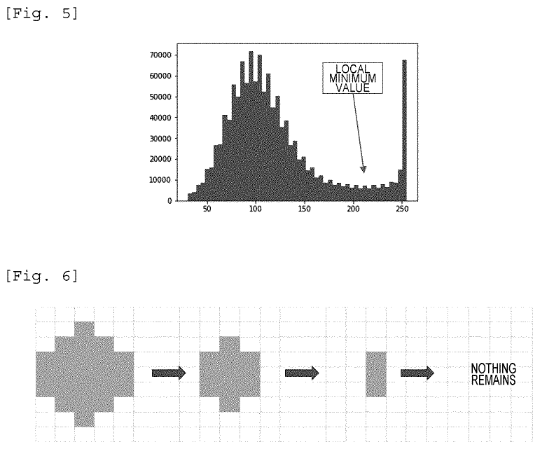

A grayscale process and a median filter process were performed based on this SEM image to obtain a sample image, Otsu's binarization was performed thereon, and an equivalent circle region was selected. Next, a region satisfying a predetermined area value range was acquired, the region was whitened, the others were blackened, portions other than the selected catalyst region were given a brightness value of 0, and a masking process was performed on the grayscale image using the image obtained just before and binarized such that portions other than the catalyst particles became the background, thereby obtaining an analysis image. In the analysis image, a histogram in which brightness values were indicated along the horizontal axis and the numbers of pixels were indicated along the vertical axis was drawn with respect to each of these catalyst regions, and binarization was performed using a brightness value at which the local minimum value of the numbers of pixel was present in regions having brightness values of 150 or more and 255 or less as a threshold value. This image is shown in FIG. 5.

Next, the area E (n=0) of a whitened composite metal oxide region was calculated (the area of one particle) from data generated by the binarization, and the total D of the areas of all of the particles was obtained.

Furthermore, as an initial process, data (data of n=1) was generated by shaving one pixel in the outermost circumference with the data of a certain catalyst region (data of n=0), and D(1) and E(1) were calculated with the catalyst region data (n=1). Next, data (data of n=2) was generated by shaving one pixel in the outermost circumference with respect to the catalyst region data (n=1), and D(2) and E(2) were calculated with the catalyst region data (n=1). The process performed in the process of n=1→n=2 was repeatedly executed, and D and E were calculated. One image of the process for shaving the outermost circumference is shown in FIG. 6.

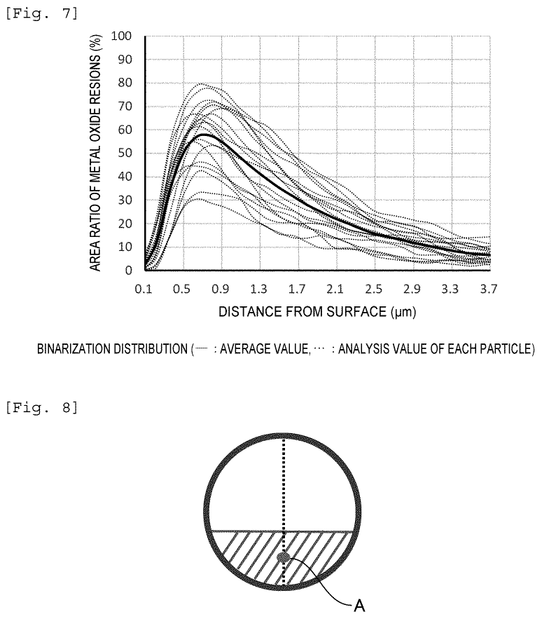

Based on numerical values obtained as a result of all of the above-described calculation processes, the relationship between the distance of the white region from the surface layer of the catalyst particle and the area ratio of the metal oxide region was graphed. The results of analyzing 20 catalyst particles as the measurement targets using Example 2 as an example are shown in FIG. 7. The average value A was calculated by acquiring the distance when the local maximum value was obtained from the numerical values that formed this graph. In addition, the standard deviation σ was calculated by acquiring the distance when the local maximum value was obtained from the numerical values that formed this graph.

### <3> B/C Calculation

Regarding each of the 20 or more randomly extracted catalyst particles, the ratio B/C of the total value B of white metal oxide regions having an area of 5000 nm² or more on the catalyst cross section to the total area C of the cross sections of the catalyst particles was calculated, and an average value thereof was calculated.

TABLE 1

| | | | | | Temperature | Temperature | Maximum | Temperature |
|---|---|---|---|---|---|---|---|---|
| | | | | | A of supply | B of carry- | reached | C of supply |
| | | | | Adjustment | port P1 side | out port P2 | temperature | port P3 side |
| | Metal | Median | | of kiln | of first | side of first | of first | of second |
| | composition of | diameter | NH₃ | inlet | cylindrical | cylindrical | cylindrical | cylindrical |
| | catalyst | (μm) | addition | temperature | body (° C.) | body (° C.) | body (° C.) | body (° C.) |
| Example 1 | Mo₁V_{0.19}Sb_{0.26}Nb_{0.14} | 51.9 | Present | Present | 150 | 380 | 380 | 580 |
| Example 2 | Mo₁V_{0.17}Sb_{0.24}Nb_{0.11} | 53.9 | Present | Present | 180 | 380 | 380 | 580 |
| Example 3 | Mo₁V_{0.23}Sb_{0.23}Nb_{0.08}W_{0.03} | 51.5 | Present | Present | 150 | 360 | 360 | 600 |
| Example 4 | Same as Example 1 | 52.7 | Present | Present | 150 | 380 | 380 | 580 |
| Example 5 | Same as Example 2 | 53.2 | Present | Present | 180 | 380 | 380 | 580 |
| Example 6 | Same as Example 3 | 52.3 | Present | Present | 150 | 360 | 360 | 600 |
| Example 7 | Same as Example 1 | 54.2 | Absent | Present | 150 | 380 | 380 | 580 |
| Comparative | Same as Example 1 | 50.8 | Present | Absent | 150 | 380 | 380 | 580 |
| Example 1 | | | | | | | | |
| Comparative | Same as Example 1 | 51.4 | Present | Absent | 150 | 380 | 380 | 580 |
| Example 2 | | | | | | | | |

| | Maximum | | | | | | | | |
|---|---|---|---|---|---|---|---|---|---|
| | reached | | | | | | | | |
| | temperature | Temperature | Temperature | | | | Pn | NH₃ | |
| | D of second | A variation | C variation | Coefficient | Variation | | conversion | burn | AN |
| | cylindrical | range | range | of | between | B/C | rate | rate | yield |
| | body (° C.) | (° C.) | (° C.) | variationσ/A | particles | (%) | (%) | (%) | (%) |
| Example 1 | 670 | 2.0 | 4.2 | 0.125 | Small | 11.5 | 90 | 16 | 56.5 |
| Example 2 | 670 | 3.5 | 3.8 | 0.122 | Small | 11.3 | 89 | 16 | 56.6 |
| Example 3 | 650 | 2.3 | 5.0 | 0.190 | Small | 12.3 | 89 | 18 | 54.9 |
| Example 4 | 670 | 5.4 | 6.6 | 0.235 | Intermediate | 12.0 | 90 | 20 | 56.0 |
| Example 5 | 670 | 8.6 | 7.2 | 0.224 | Intermediate | 13.5 | 90 | 22 | 55.4 |
| Example 6 | 650 | 5.5 | 8.0 | 0.232 | Intermediate | 13.3 | 89 | 22 | 54.0 |
| Example 7 | 670 | 3.1 | 4.5 | 0.227 | Intermediate | 12.7 | 90 | 20 | 55.8 |
| Comparative | 670 | 15.4 | 19.2 | 0.335 | Large | 11.9 | 90 | 25 | 55.6 |
| Example 1 | | | | | | | | | |
| Comparative | 670 | 16.0 | 20.5 | 0.422 | Large | 10.9 | 89 | 27 | 55.5 |
| Example 2 | | | | | | | | | |

As is clear from Table 1, all of the catalysts obtained in Examples 1 to 7 had a low ammonia burn rate and were capable of synthesizing acrylonitrile at a high efficiency. On the other hand, the catalysts obtained in Comparative Examples 1 and 2 were the same metal compositions as in Examples 1, 4, and 7, but had a high ammonia burn rate and a poor acrylonitrile synthesis efficiency compared with those in Examples 1, 4, and 7.

### REFERENCE SIGNS LIST

1: Heat exchanger, 2: storage container of dry powder, 3: temperature measurement point, 4: injected powder collection machine, 5: calcining machine, 11: pipe, 12: pipe, 13: pipe, 14: pipe, 15: pipe

1. A method for producing a catalyst that is used in a gas phase catalytic oxidation reaction or gas phase catalytic ammoxidation reaction, the method comprising:
a drying step of drying a precursor of the catalyst to obtain dry particles;
a first supplying step of supplying the dry particles to a first cylindrical body; and
a first calcining step of calcining the dry particles supplied to the first cylindrical body to obtain first calcined particles,
wherein the first cylindrical body comprises a supply port P1 that supplies the dry particles into the cylindrical body at one end T1 side, a carry-out port P2 that carries out the calcined particles to an outside of the cylindrical body at the other end T2 side, the T1 and T2 sides being arranged in a rotation axis direction of the cylindrical body, and heating means M1 that heats an inside of the cylindrical body along the rotation axis direction, and
a variation range of a temperature A of a supply port P1 side in the first cylindrical body is 10° C. or less.

2. The method for producing the catalyst according to claim 1, wherein:
the first cylindrical body further comprises a plurality of temperature measurement means M2, that measure temperatures of substantially a central portion along the rotation axis direction, in the tubular body,
in the first supplying step, the dry particles are supplied to the supply port P1 by gas transportation,
the temperature A is measured by temperature measurement means M2′ out of the temperature measurement means M2, the temperature measurement means M2′ being disposed on the supply port P1 side, and
the temperature A is adjusted by controlling a temperature of a gas that is used for the gas transportation.

3. The method for producing the catalyst according to claim 2, wherein, in the gas transportation, an inert gas is used.

4. The method for producing the catalyst according to claim 2, wherein a supply rate of the dry particles to the supply port P1 is 0.1 kg/hr or higher and 100 kg/hr or lower per cubic meter of a volume of the first cylindrical body.

5. The method for producing the catalyst according to claim 1, wherein:
in the drying step, spray drying of the precursor is performed,
in the first supplying step, the dry particles are continuously supplied, and
in the first calcining step, the dry particles are continuously calcined, and a maximum reached temperature is 350° C. to 500° C.

6. The method for producing the catalyst according to claim 1, wherein, in the first calcining step, a temperature is controlled by the heating means M1 such that the temperature A reaches a target temperature t1 selected from 100° C. to 300° C. and/or a temperature B of a carry-out port P2 side of the first cylindrical body reaches a target temperature t2 selected from 350° C. to 500° C.

7. The method for producing the catalyst according to claim 1, further comprising:
a second supplying step of supplying the first calcined particles to a second cylindrical body; and
a second calcining step of calcining the first calcined particles supplied to the second cylindrical body to obtain second calcined particles.

8. The method for producing the catalyst according to claim 7, wherein:
in the second supplying step, the first calcined particles are continuously supplied, and
in the second calcining step, the first calcined particles are continuously calcined, and a maximum reached temperature is 600° C. to 800° C.

9. The method for producing the catalyst according to claim 7, wherein:
the second cylindrical body comprises a supply port P3 that guides the first calcined particles into a cylindrical body at one end T3 side, a carry-out port P4 that carries out the first calcined particles at the other end T4 side, the T3 and T4 sides being arranged in a rotation axis direction of the cylindrical body, heating means M3 that heats an inside of the cylindrical body along the rotation axis direction, and a plurality of temperature measurement means M4 that measure temperatures of substantially a central portion of the cylindrical body along the rotation axis direction, and
in the second calcining step, a temperature is controlled with the heating means M3 such that a temperature C of a supply port P3 side of the second cylindrical body reaches a target temperature t3 selected from 600° C. to 800° C. and/or a maximum reached temperature D of the second cylindrical body reaches a target temperature t4 selected from 500° C. to 800° C.

10. The method for producing the catalyst according to claim 7, wherein the first cylindrical body and the second cylindrical body are rotary kilns.

11. The method for producing the catalyst according to claim 1, comprising:
a preparation step of preparing a precursor of the catalyst,
wherein, in the preparation step, ammonia water is added to a liquid mixture of a metal compound.

12. A catalyst that is used in a gas phase catalytic oxidation reaction or gas phase catalytic ammoxidation reaction, wherein:
the catalyst comprises catalyst particles each having a composite metal oxide and a support that supports the composite metal oxide,
the catalyst particles have a median diameter of 20 μm or more and 150 μm or less,
a shape of the catalyst particle is spherical, and
in a binarization processed image BP₂ obtained by performing a binarization process for classifying regions into a white region and a black region that are defined in the following <1> on a cross-sectional image showing the catalyst particles and having an area of 1200 μm² or more obtained by SEM backscattered electron image observation based on the following <0>, σ/A that is calculated in the following <2> satisfies 0.10 or more and 0.30 or less:
<0> acquisition conditions for cross-sectional image with SEM
accelerating voltage: 15 kV,
magnification: 700 times,
resolution: 512 dpi,
image size: 2560 pixels×1920 pixels, eight-bit depth,
brightness value of background other than catalyst particles: 0 to 40,
peak position of brightness value of portion of support: 70 to 140, and
brightness value of central portion of composite metal oxide region: 255,
<1> binarization process
[Acquisition of image for catalyst analysis]
(i) a grayscale process is performed on the cross-sectional image of the catalyst,
(ii) a median filter process in which a kernel size is set to 9 pixels×9 pixels is performed on the image after the (i),
(iii) Otsu's binarization on the image after the (ii) is performed,
(iv) contour extraction is performed on the image after the (iii) based on a binarization result,
(v) on the image after the (iv), a process for whitening a region where the number of pixels in the contour is 250000 pixels or more and 750000 pixels or less is performed, a process for blackening a region outside the contour that is a region outside the region where the number of pixels in the contour is 250000 pixels or more and 750000 pixels or less is performed, and a binarization processed image BP₁ is acquired, and
(vi) a masking process on the image after the (i) is performed based on the blackened pixel information of the binarization processed image BP₁ acquired in the (v), and an image for catalyst analysis in which outer regions of contours of the catalyst particles are regarded as black regions and insides of the contours are regarded as catalyst particle regions is acquired,
[Process for specifying white region based on image for catalyst analysis]
(vii) a median filter process in which a kernel size is set to 5 pixels×5 pixels is performed on the image for catalyst analysis obtained in the (vi), and
(viii) a binarization process in which a brightness value at which the number of pixels becomes a local minimum value in a brightness value range of 150 or more and 255 or less is defined as a threshold value is performed on the image after the (vii), insides of the catalyst particles are classified into white regions and black regions, and a binarization processed image BP₂ in which the white regions are specified is acquired,
<2> σ/A calculation
(I) in the binarization processed image BP₂ acquired in the <1>, an area C₀ of one arbitrary catalyst particle region and an area W₀ of the white region in the catalyst particle region are calculated,
(II) outermost edges E₀ that are vertically and horizontally adjacent to the one arbitrary catalyst particle region used in the (I) and are composed of each pixel unit are shaved, and an area C₁ of the remaining catalyst particle region and an area W₁ of the white region in the remaining catalyst particle region are calculated,
(III) a ratio F₀=(W₀−W₁)/(C₀−C₁) of the white region to the catalyst particle region in the outermost edges E₀ is calculated,
(IV) outermost edges E₁ that are vertically and horizontally adjacent to the remaining catalyst particle region in the (II) and are composed of each pixel unit are shaved, and an area C₂ of the remaining catalyst particle region and an area W₂ of the white region in the remaining catalyst particle region are calculated,
(V) a ratio F₁=(W₁−W₂)/(C₁−C₂) of the white region to the catalyst particle region in the outermost edges E₁ is calculated,
(VI) the same processes as the (IV) and the (V) are repeated until outermost edges Eₙ that make it impossible to shave outermost edges any longer are shaved, and Cₙ, Wₙ, and Fₙ are calculated,
where Fₙ is represented by Fₙ=(Wₙ−Wₙ₊₁)/(Cₙ−Cₙ₊₁),
(VII) when a local maximum value among F₁ to Fₙ is represented by Fₖ (0≤k≤n), a distance Dₖ from a surface of the catalyst particle to an outermost edge Eₖ indicating the local maximum value is defined as Dₖ=0.14*(k+1)−0.07, and Dₖ is calculated,
(VIII) operations of the (I) to (VI) are performed on 20 arbitrary and different catalyst particle regions that are obtained from the binarization processed image BP₂, and 20 Dₖ's corresponding to the individual catalyst particle regions are obtained, and
(IX) an average of the 20 Dₖ's obtained in the (VIII) is represented by A, a sample standard deviation of the 20 Dₖ's is represented by σ, and σ/A is calculated.

13. The catalyst according to claim 12, wherein, in the SEM backscattered electron image observation, a ratio B/C of a total value B of white metal oxide regions having an area of 5000 nm² or more on a catalyst cross section to a total area C of cross sections of the catalyst particles is 13% or less.

14. The catalyst according to claim 12, wherein the composite metal oxide satisfies the following composition formula:
Mo₁VₐSb_{b}Nb_{c}T_{d}ZₑOₙ
(in the formula, T represents at least one element selected from Ti, W, Mn, and Bi, Z represents at least one element selected from La, Ce, Yb, and Y, a, b, c, d, or e is an atomic ratio of each element when Mo is regarded as one and is each in a range of 0.05≤a≤0.35, 0.05≤b≤0.35, 0.01≤c≤0.15, 0≤d≤0.10, or 0≤e≤0.10, and n is a value satisfying a balance of a valence).
